(19) United States
(12) Patent Application Publication
(10) Pub. No.: US 2025/0175982 A1
(43) Pub. Date: May 29, 2025

(54) DIFFERENTIAL OFFSETS FOR COOPERATIVE RECEPTION BETWEEN MULTIPLE USER EQUIPMENTS

(71) Applicant: QUALCOMM Incorporated, San Diego, CA (US)

(72) Inventors: Diana MAAMARI, San Diego, CA (US); Mostafa KHOSHNEVISAN, San Diego, CA (US); Prashanth Haridas HANDE, San Diego, CA (US); Peerapol TINNAKORNSRISUPHAP, San Diego, CA (US); Mickael MONDET, Louannec (FR); Hyun Yong LEE, San Diego, CA (US); Huilin XU, Temecula, CA (US)

(21) Appl. No.: 18/522,559

(22) Filed: Nov. 29, 2023

(51) Int. Cl. H04W 72/1273; H04L 1/1812; H04W 72/1268; H04W 72/21; H04W 72/231

(52) U.S. Cl. CPC H04W 72/1273; H04L 1/1812; H04W 72/1268; H04W 72/21; H04W 72/231

(57) ABSTRACT

Methods, systems, and devices for wireless communication are described. A first user equipment (UE) may transmit a control message that indicates one or more differential offsets, the one or more differential offsets to be applied to one or both of a first time duration to process a physical downlink shared channel (PDSCH) transmission at the first UE and a second time duration to prepare a physical uplink shared channel (PUSCH) transmission at the first UE. The first UE may receive information associated with a data message from a network entity and a second UE in association with a cooperative reception between the first UE and the second UE. The first UE may transmit one or more uplink messages based on the one or more differential offsets. The one or more uplink messages may include feedback associated with the data message.

### FIELD OF TECHNOLOGY

The following relates to wireless communication, including differential offsets for cooperative reception between multiple user equipments (UEs).

### BACKGROUND

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

In some cases, a wireless device may support an extended reality (XR), a virtual reality (VR), or an augmented reality (AR) application and may be understood as an XR, VR, or AR wireless device. In some aspects, XR, VR, or AR wireless devices may have relatively small form-factors and, accordingly may have a limited (e.g., relatively small) quantity of antennas. Such a limited quantity of antennas may hinder a spatial multiplexing capability of the XR, VR, or AR wireless device.

### SUMMARY

The described techniques relate to improved methods, systems, devices, and apparatuses that support differential offsets for cooperative reception between multiple user equipments (UEs). For example, the described techniques provide for (e.g., enable or support) a UE to indicate one or more differential offsets to be applied to a processing time, a preparation time, or both. The UE may transmit a message to a network entity indicating a first differential offset to be applied to a first time duration to process a physical downlink shared channel (PDSCH) message and a second differential offset to be applied to a second time duration to prepare a physical uplink shared channel (PUSCH) transmission. In some implementations, the first differential offset and the second differential offset may accommodate for a cooperation link between the UE and another UE. For example, the differential offsets may be applied by the UE to account for additional time for PDSCH processing and PUSCH preparation based on use of the cooperation link, a condition of the cooperation link, or both.

### BRIEF DESCRIPTION OF THE DRAWINGS

FIGS. 1 and 2 show examples of wireless communication systems that support differential offsets for cooperative reception between multiple user equipments (UEs) in accordance with one or more aspects of the present disclosure.

FIGS. 3A, 3B, and 3C show examples of timing diagrams that support differential offsets for cooperative reception between multiple UEs in accordance with one or more aspects of the present disclosure.

FIGS. 4A and 4B show examples of timing diagrams that support differential offsets for cooperative reception between multiple UEs in accordance with one or more aspects of the present disclosure.

FIGS. 5-8 show examples of process flows that support differential offsets for cooperative reception between multiple UEs in accordance with one or more aspects of the present disclosure.

FIG. 9 shows an example of a split stack diagram that supports differential offsets for cooperative reception between multiple UEs in accordance with one or more aspects of the present disclosure.

FIGS. 10 and 11 show block diagrams of devices that support differential offsets for cooperative reception between multiple UEs in accordance with one or more aspects of the present disclosure.

FIG. 12 shows a block diagram of a communications manager that supports differential offsets for cooperative reception between multiple UEs in accordance with one or more aspects of the present disclosure.

FIG. 13 shows a diagram of a system including a device that supports differential offsets for cooperative reception between multiple UEs in accordance with one or more aspects of the present disclosure.

FIGS. 14 and 15 show block diagrams of devices that support differential offsets for cooperative reception between multiple UEs in accordance with one or more aspects of the present disclosure.

FIG. 16 shows a block diagram of a communications manager that supports differential offsets for cooperative reception between multiple UEs in accordance with one or more aspects of the present disclosure.

FIG. 17 shows a diagram of a system including a device that supports differential offsets for cooperative reception between multiple UEs in accordance with one or more aspects of the present disclosure.

FIGS. 18-21 show flowcharts illustrating methods that support differential offsets for cooperative reception between multiple UEs in accordance with one or more aspects of the present disclosure.

### DETAILED DESCRIPTION

Some wireless devices may have relatively small form-factors compared with other devices. As described herein, a form-factor may refer to any one or more of a size, a configuration, or a physical arrangement of a wireless device, such as a user equipment (UE). For example, a wireless device with a relatively small form-factor may be equivalently understood as a device with a relatively small size. Such a (relatively small) wireless device may be associated with relatively fewer antennas (e.g., transmit and/or receive antennas) than other wireless devices, limiting gains (e.g., multiple-input multiple-output (MIMO) rank gains) associated with received signals. As an example, an extended reality (XR), virtual reality (VR), or augmented reality (AR) device, such as an augmented reality (AR)-glass, or other wearable devices, may be limited to relatively fewer receive antennas (e.g., 2 receive antennas in an AR-glass, 1 receive antenna for a watch, etc.) as compared to, for example, larger wireless devices such as laptops, televisions (TVs), or consoles. In other words, a wireless device with a relatively small form-factor may have relatively fewer antennas, as compared to a wireless device with a relatively large form-factor, because of space constraints or limitations.

To increase gains and system throughput, a wireless device (with a relatively small form-factor or any other device targeting greater MIMO rank gains) may cooperate with another device. For example, an anchor UE (e.g., the wireless device with the small form-factor or the device targeting greater MIMO rank gains) may cooperate with a companion UE to effectively increase a spatial multiplexing capability, thereby increasing gains and system throughput. For example, the anchor UE and the companion UE may participate in a cooperative reception scheme according to which the anchor UE and the companion UE both receive data intended for the anchor UE, with the companion UE forwarding (e.g., transmitting, relaying, or otherwise conveying) information associated with the data to the anchor UE in accordance with a type of cooperation. The cooperation may include generation of in-phase and quadrature (I/Q) samples, generation of log-likelihood ratio (LLR) values, or transport block (TB) processing at the companion UE. In other words, the information conveyed, forwarded, relayed, or transmitted by the companion UE to the anchor UE may include I/Q samples associated with the data, LLR values associated with the data, or a TB associated with the data (depending on the type of cooperation).

Additionally, the anchor UE may be expected to transmit feedback (e.g., hybrid automatic repeat request (HARQ) feedback) associated with the data according to a timeline configured by a network entity. However, the timeline may not account for additional time to forward the information from the companion UE to the anchor UE. Thus, to account for forwarding the information via a cooperation link, the timeline may be adjusted to include (e.g., account for) additional processing and forwarding time at the companion UE. Further, other scenarios may arise in which a UE may use additional time to prepare for a transmission, such as an uplink data transmission, and timelines associated with preparation of the transmission may be adjusted to include such additional time.

In some implementations, for example, a UE may report one or more differential offsets to be applied to a processing time, a preparation time, or both. Such one or more differential offsets may account for delays associated with cooperative reception between a companion UE and an anchor UE, among other time delays, buffers, or extensions a UE may select to use for any downlink transmission processing time, uplink transmission preparation time, or both. In some examples, the UE may indicate a first differential offset for a physical downlink shared channel (PDSCH) processing time (e.g., an N1 offset, such as a time domain offset to be applied to the end of, such as to extend, an N1 value) and a second differential offset for physical uplink shared channel (PUSCH) preparation time (e.g., an N2 offset, such as a time domain offset to be applied to the end of, such as to extend, an N2 value). In such examples, the first offset and the second offset may be added to a first time duration and a second time duration configured for PDSCH processing and PUSCH preparation, respectively. In some examples, the first differential offset, the second differential offset, or both may be based on a condition (e.g., a link condition) of the cooperation link between the companion UE and the anchor UE or based on a type of cooperation between the companion UE and the anchor UE (as different types of cooperation may be associated with different processing delays). The network entity may adjust and/or indicate a timing scheme according to the indicated differential offsets and, likewise, the UE may transmit one or more uplink messages in accordance with the indicated differential offsets.

The described techniques may be implemented to realize one or more advantages, including greater communication reliability by enabling the UE to obtain more processing and/or preparation time. In accordance with such greater communication reliability, the described techniques may further be implemented to realize greater spectral efficiency, higher data rates, greater system capacity, lower latency, and reduced power consumption (by way of, for example, reducing retransmissions or communication errors). Further, the signaling mechanisms described herein may be implemented to realize greater flexibility and more dynamic operation, which may result in an improved user experience by enabling a UE to make dynamic timing adjustments (e.g., based on changing applications or use cases at the UE).

Aspects of the disclosure are initially described in the context of wireless communication systems. Aspects of the disclosure are also described in the context of timing diagrams, process flows, and a split stack diagram. Aspects of the disclosure are further illustrated by and described with reference to apparatus diagrams, system diagrams, and flowcharts that relate to differential offsets for cooperative reception between multiple UEs.

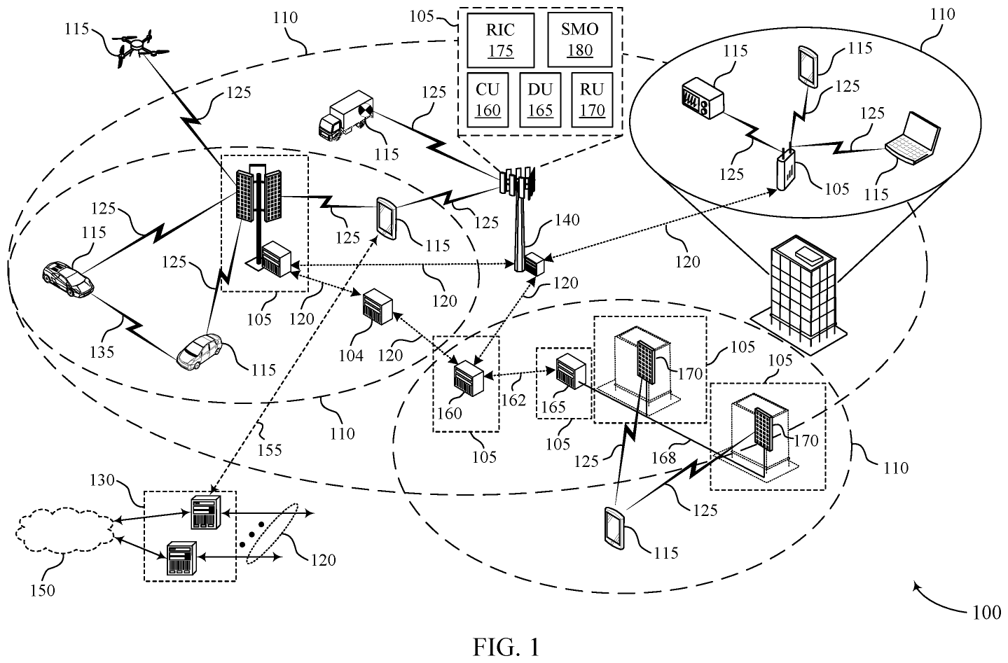

FIG. 1 shows an example of a wireless communication system 100 that supports differential offsets for cooperative reception between multiple UEs in accordance with one or more aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communication system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communication systems (e.g., wireless communication system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support differential offsets for cooperative reception between multiple UEs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

The wireless communication system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred—the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communication system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a UE 115 may indicate a differential offset to be applied to a processing time, a preparation time, or both. For example, the UE 115 may transmit a message to the network entity 105 indicating a first differential offset to be applied to a first time duration to process a PDSCH message and a second differential offset to be applied to a second time duration to prepare a PUSCH transmission. In some implementations, the first differential offset and the second differential offset may accommodate for (processing timelines associated with) a cooperation link between the UE 115 and another UE 115, which may be referred to as a companion UE 115. For example, the differential offsets may be applied by the UE 115 to account for additional time for PDSCH processing and/or PUSCH preparation based on use of the cooperation link, a condition of the cooperation link, or both, among other example scenarios in which the UE 115 may select, determine, or expect to use additional PDSCH processing and/or PUSCH preparation time. In other words, in the example of a cooperative reception scheme between the UE 115 and a companion UE 115, the differential offsets may account for additional time to allow for (at least partial) processing and forwarding by the companion UE 115 to the UE 115.

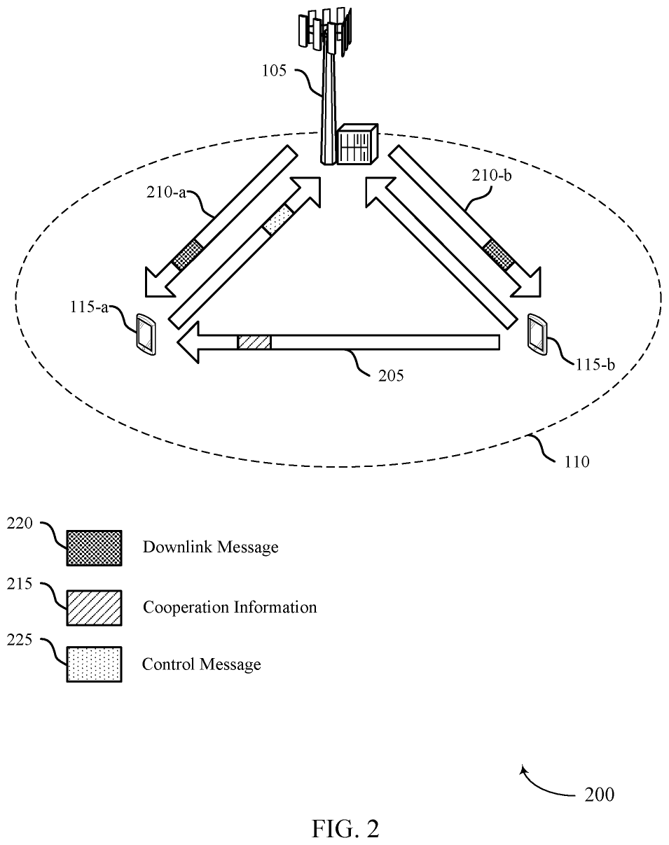

FIG. 2 shows an example of a wireless communication system 200 that supports differential offsets for cooperative reception between multiple UEs in accordance with one or more aspects of the present disclosure. The wireless communication system 200 may implement or be implemented by various aspects of the wireless communication system 100. For example, the wireless communication system 200 may include a network entity 105, a coverage area 110, a UE 115-a, and a UE 115-b, which may represent examples of corresponding devices as illustrated by and described with reference to FIG. 1.

The wireless communication system 200 may support cooperation between a companion UE and an anchor UE. For example, the companion UE, such as the UE 115-b, may forward signals to the anchor UE, such as the UE 115-a, via a cooperation link 205 (e.g., a co-op link, a sidelink, a P2P link, a D2D link, etc.). Cooperation between the UE 115-a and the UE 115-b may increase a spatial multiplexing capability at the UE 115-a by increasing a virtual quantity of antennas of the UE 115-a.

For example, the UE 115-a may have a quantity of antennas below a threshold quantity of antennas, where a quantity of antennas below the threshold may be associated with limited spatial multiplexing capabilities. In other words, the UE 115-a may be an example of a small form-factor device, such as an XR, VR, or AR device (e.g., an AR-glass) or a wearable. That is, the UE 115-a may have one or two receive antennas, which may be relatively few as compared to a larger form-factor device having four or more receive antennas. Small form-factor devices may be associated with the limited spatial multiplexing capabilities due to the reduced quantity of receive antennas, which may be associated with a high antenna correlation factor, limiting MIMO rank gains.

The UE 115-a may increase the virtual (e.g., effective) quantity of antennas to increase the spatial multiplexing capability-UE cooperation. As an example, the UE 115-a, having two receive antennas, may increase a quantity of receive antennas by use of the companion UE having four receive antennas, which may add up to six total “virtual” antennas. As another example, the UE 115-a may have two receive antennas and the UE 115-b may have one receive antenna, adding up to three total “virtual” antennas. That is, generally, the UE 115-a and the UE 115-b may be aggregated into a “virtual” UE (e.g., a single virtual UE) to which the network entity 105 may transmit signaling. For example, the network entity 105 may transmit signaling to the UE 115-a via a first path and a second path. The first path may be a direct link (e.g., a downlink communication link 210-a, a Uu link, etc.) from the network entity 105 to the UE 115-a, and the second path may be a relay link from the network entity 105 to the UE 115-b to the UE 115-b. That is, the second path may include a downlink communication link 210-b from the network entity 105 to the UE 115-b and a sidelink communication link (e.g., the cooperation link 205) from the UE 115-b to the UE 115-a.

In some examples, the use of the cooperation link 205 may increase the spatial multiplexing capability, which may be associated with an increase in user perceived throughput, system throughput, or both. The cooperation link 205 may have a relatively low power, high bandwidth, low latency, and/or high reliability compared to, for example, a downlink communication link 210-a or a downlink communication link 210-b. For example, the wireless communication system 200 may support ultra-wideband data communication, NR sidelink (e.g., licensed or unlicensed) communication, Wi-Fi communication, Bluetooth communication, or universal serial bus (USB) communication, and the cooperation link 205 may be associated with any one or more of such communication modes.

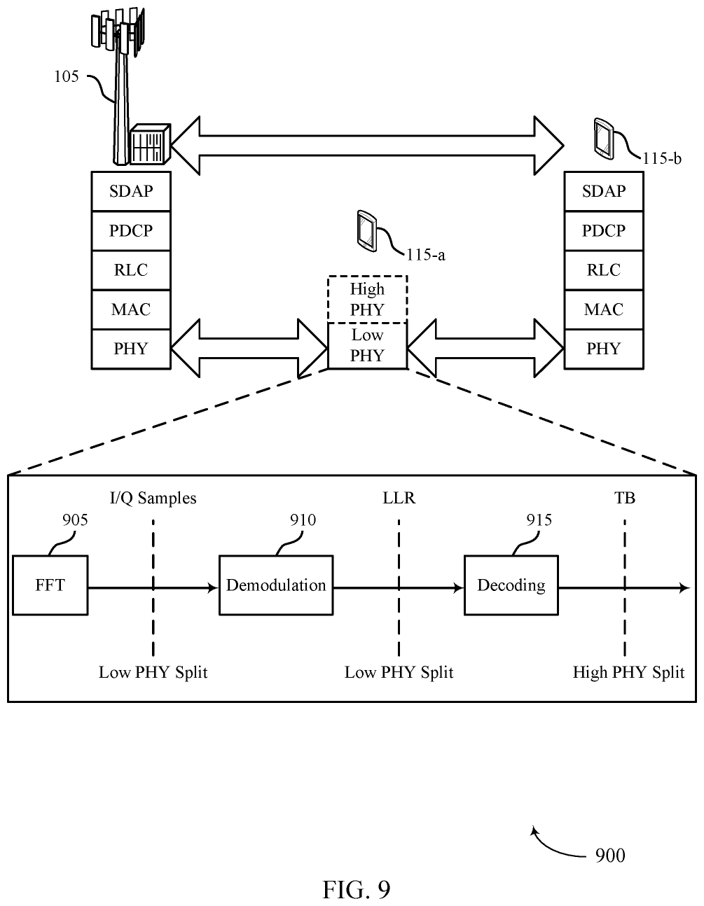

The network entity 105 may communicate signals to the UE 115-a and the UE 115-b according to different protocol stacks. For example, the network entity 105 may communicate a first signal via full protocol stack to the anchor UE, the UE 115-a, and the network entity 105 may communicate a second signal via a split (e.g., partial) protocol stack to the companion UE, the UE 115-b. The full and split protocol stacks may be described in further detail elsewhere herein, including with reference to FIG. 9.

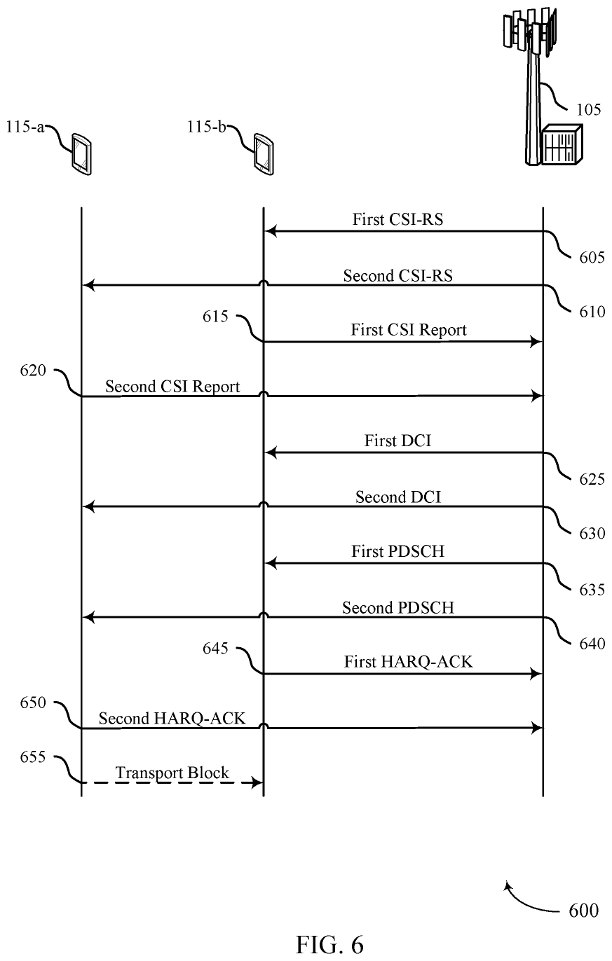

In some examples, the UE 115-b may transmit cooperation information 215 to the UE 115-a via the cooperation link 205. The cooperation information 215 may include TBs, I/Q samples, or LLR values. TB forwarding, I/Q forwarding, and LLR forwarding may be described in further detail elsewhere herein, including with reference to FIGS. 6-8. Generally, the network entity 105 may transmit a downlink message 220 to the UE 115-a and the UE 115-b. The UE 115-b may perform some (e.g., partial) processing of the downlink message 220 and transmit information related to the downlink message 220 to the UE 115-a, or, in some other examples, forward the downlink message 220 itself via the cooperation information 215 (e.g., relay the downlink message 220).

As an example, the network entity 105 may transmit a first TB to the UE 115-a via a first PDSCH and a second TB to the UE 115-b via a second PDSCH, or, in some other examples, a same TB to the UE 115-a and the UE 115-a via a same PDSCH. As another example, for I/Q forwarding, the network entity 105 may transmit a same TB to the UE 115-a and the UE 115-b via the same PDSCH. The UE 115-b may generate I/Q samples based on receiving the TB and forward the I/Q samples to the UE 115-a, and the UE 115-a may not transmit feedback (e.g., HARQ-ACK) in response to the TB until the I/Q samples are received from the UE 115-b. In some cases, forwarding the TB, I/Q samples, or LLR values by the UE 115-b via the cooperation link 205 may cause the UE 115-a to be unable to meet a timeline related to feedback transmission set by the network entity 105.

For example, the network entity 105 may configure the UE 115-a, the UE 115-b, or both with a timeline for feedback transmission, uplink message transmission, or both. That is, the network entity 105 may transmit an indication of a timing indicator denoting a time gap between a PDSCH slot and a PUCCH slot, and the UE 115-a may be expected to transmit feedback (e.g., an acknowledgment (ACK) or a negative acknowledgment (NACK)) associated with data received via the PDSCH slot in the PUCCH slot. Additionally, or alternatively, the network entity 105 may transmit an indication of a time domain resource assignment denoting a time gap between a downlink control information (DCI) slot and a PUSCH slot, and the UE 115-a may be expected to transmit an uplink data message scheduled by DCI received via the DCI slot via the PUSCH slot. However, the network entity 105 may not consider an amount of time to forward communications to the UE 115-a by the UE 115-b via the cooperation link 205 when configuring the timeline (e.g., in cooperative reception use cases), or any other time delays, buffers, or extensions the UE 115-a may select, determine, or otherwise expect to use in addition to (e.g., on top of) relatively more statically configured, selected, or indicated capability timelines (e.g., such as any amount of time the UE 115-a may select, determine, or otherwise expect to use in addition to relatively more static N1 or N2 timing values). Accordingly, in some implementations of the present disclosure, the UE 115-a may transmit an indication of one or more differential offsets to be applied to a PDSCH processing time (e.g., an N1 timing value), a PUSCH preparation time (e.g., an N2 timing value), or both to account for additional time the UE 115-a may select, determine, or otherwise expect to use in addition to the relatively more statically configured, selected, or indicated capability timelines.

In some examples, the UE 115-a may transmit the indication of (e.g., indicate, report, or otherwise signal) the one or more differential offsets via a control message 225. The one or more differential offsets may be applied to static (or at least relatively more static) processing timelines (e.g., processing and/or preparation timelines associated with, such as defined or outlined by, N1 and/or N2). Additionally, or alternatively, the UE 115-a may adapt the one or more differential offsets according to or to compensate for a condition of the cooperation link 205. For example, the UE 115-a may increase a duration of a differential offset based on determining that a link condition of the cooperation link 205 is relatively poor, or, the UE 115-a may decrease a duration of the differential offset based on determining that the link condition of the cooperation link 205 is relatively strong.

In some examples, the UE 115-a may transmit the indication of the one or more differential offsets via a medium access control-control element (MAC-CE). The UE 115-a may transmit the MAC-CE via a configured uplink grant, or, in some other examples, request uplink resources by transmitting a scheduling request to the network entity 105. In some examples, the UE 115-a may transmit the indication of the one or more differential offsets via a dynamic capability indication. In other words, the UE 115-a may indicate the one or more differential offsets via dynamic capability reporting to the network entity 105.

Additionally, or alternatively, the indication may include multiple differential offsets. That is, the UE 115-a may indicate a set of offsets and transmit a (dynamic) message (e.g., an uplink control information (UCI) message via a PUCCH or PUSCH) indicating which offset(s) of the set of offsets are to be applied (e.g., based on one or both of a link condition of the cooperation link 205 and a choice of cooperation between the UE 115-a and the UE 115-b). In other words, the UE 115-a may indicate multiple pairs of offsets, where each respective pair of the multiple pairs includes a respective first offset for PDSCH processing (e.g., a respective N1 differential offset) and a respective second offset for PUSCH preparation (e.g., a respective N2 differential offset), and the message (e.g., UCI) may indicate that a pair of the multiple pairs is to be applied by the UE 115-a. In some implementations, the UE 115-a and the network entity 105 may exchange signaling associated with the multiple pairs of offsets. For example, a first of the UE 115-a and the network entity 105 may transmit (e.g., via one or more RRC information elements, one or more MAC-CEs, one or more DCI messages, one or more UCI messages, or any combination thereof) information indicative of the multiple pairs of offsets to a second of the UE 115-a and the network entity 105 (e.g., to inform the second of the UE 115-a and the network entity 105 of the available or possible pairs of offsets). Additionally, or alternatively, the multiple pairs of offsets may be pre-configured or pre-loaded (e.g., in one or more memories) at one or both of the UE 115-a and the network entity 105, such as in accordance with a network specification.

The network entity 105 may configure a timing scheme based on receiving the indication. For example, the network entity 105 may consider a processing capability of the UE 115-a as an original time duration plus the one or more differential offsets. In other words, the network entity 105 may determine a total PDSCH processing time for the UE 115-a as a summation of an original PDSCH processing time (e.g., according to a preconfigured processing time or a processing time prior to the application of a differential offset, such as a processing time indicated by an N1 timing value) and the first differential offset associated with PDSCH processing. Similarly, the network entity 105 may determine a total PUSCH preparation time for the UE 115-a as a summation of an original PUSCH preparation time (e.g., according to a preconfigured preparation time or a preparation time prior to the application of a differential offset, such as a preparation time indicated by an N2 timing value) and the second differential offset associated with PUSCH preparation.

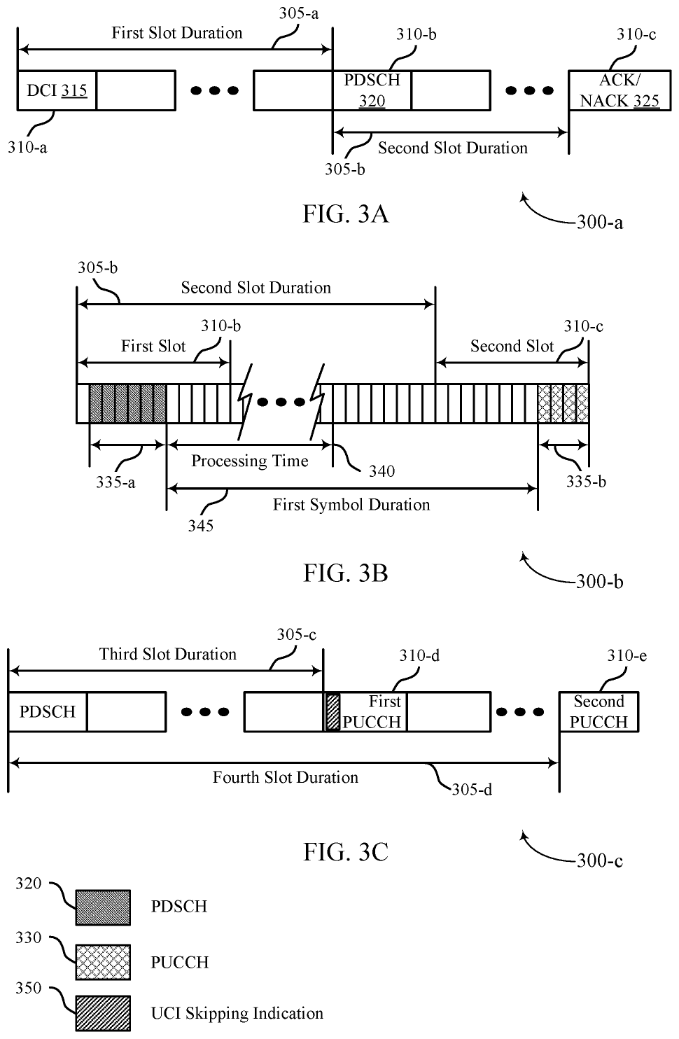

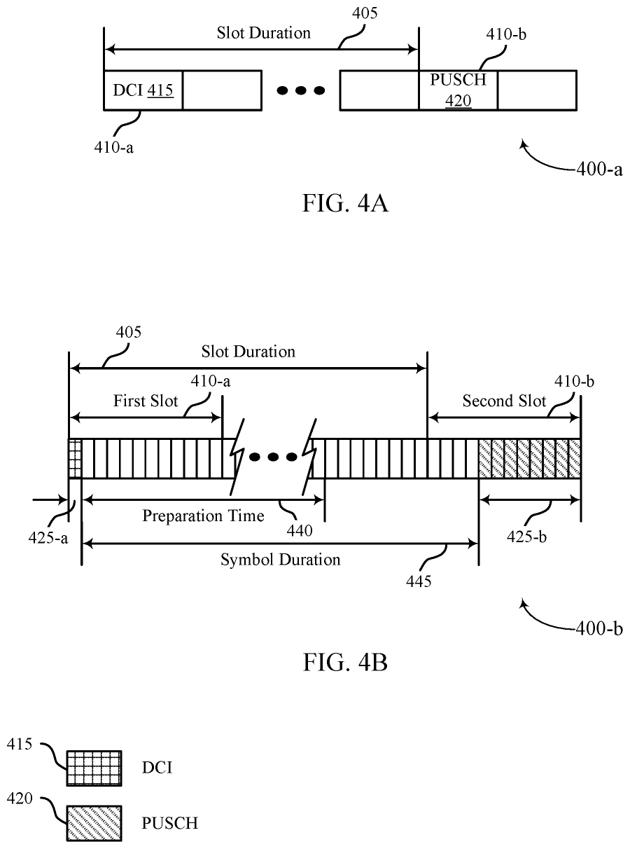

The network entity 105 may determine a first slot offset (e.g., K1, or a value associated with, such as indicated by, K1) between a PDSCH slot and a UCI slot based on the total PDSCH processing time and a second slot offset (e.g., K2, or a value associated with, such as indicated by, K2) between a DCI slot and a PUSCH slot based on the total PUSCH preparation time. That is, the first slot offset may denote, define, indicate, identify, or determine a quantity of slots between a slot including a PDSCH message (such as a leading edge or start of the slot including the PDSCH message) and a slot including a PUCCH message (such as a leading edge or start of the slot including the PUCCH message, which may be understood as an ACK/NACK message), while a second slot offset may denote, define, indicate, identify, or determine a quantity of slots between a slot including a DCI message (such as a leading edge or start of the slot including the DCI message) and a slot including a PUSCH message (such as a leading edge or start of the slot including the PUSCH message). The first slot offset may be associated with a time duration greater than or equal to the total PDSCH processing time at the UE 115-a, and the second slot offset may be associated with a time duration greater than or equal to the total PUSCH preparation time at the UE 115-a. In other words, the network entity 105 may configure the first slot offset and the second slot offset to be larger than or equal to at least the PDSCH processing time and the PUSCH preparation time, respectively. The first slot offset, the second slot offset, and the differential offsets are described in greater detail elsewhere herein, including with reference to FIGS. 3A, 3B, and 3C and FIGS. 4A and 4B.

In some implementations, the UE 115-a may apply the one or more differential offsets after receiving a next DCI. For example, the UE 115-a may receive a downlink message 220 that indicates a same identifier as the control message 225 including the one or more differential offsets. As an example, the downlink message 220 may include a DCI indicating a HARQ identifier which is the same as a HARQ identifier of a PUSCH including a MAC-CE indicating the one or more differential offsets. In some examples, the DCI indicating the HARQ identifier may have a toggled new data indicator (NDI). The toggled NDI may indicate, to the UE 115-a, that the network entity 105 successfully decoded the MAC-CE. Additionally, or alternatively, the network entity 105 may explicitly indicate (e.g., via a response message) to the UE 115-a that the MAC-CE is successfully decoded.

In some implementations, the UE 115-a may apply the one or more differential offsets by adding a constant offset to a preconfigured slot offset. For example, the UE 115-a may receive an indication of the constant offset from the network entity 105 or determine the constant offset based on a previously configured slot offset. The received or determined constant offset may be used by the UE 115-a and the network entity 105. That is, each device of the wireless communication system 200 may operate according to a timing scheme including the constant offset. In some examples, the constant offset may be a function in units of slots (rather than symbols) to default K1/K2 values. Further, in some examples, multiple constant offsets may be used, such as a first constant offset to extend K1 and a second constant offset to extend K2. In either set of examples, the one or more constant offsets may accommodate (e.g., include within their time domain duration) the one or more differential offsets.

Additionally, or alternatively, an RRC configuration may support an extended range of slot offsets. That is, the network entity 105 may transmit an indication of the RRC configuration to the UE 115-a including an extended range of slot offsets, for example, in addition to or rather than applying the constant offset to the preconfigured offset. In some examples, the network entity 105 may indicate (e.g., via a MAC-CE) a new set of slot offsets based on receiving the indication of the one or more differential offsets via the control message 225. The new set of slot offsets may override (e.g., replace) the slot offsets (e.g., the K1/K2 values) of the RRC configuration. Additionally, or alternatively, the network entity 105 may indicate (e.g., via the MAC-CE) which of the extended range of slot offsets of the RRC configuration are to be used. That is, the network entity 105 may transmit the MAC-CE including an indication of a pair of slot offsets of the extended range of slot offsets to be used by the UE 115-a. For example, if there are N sets of N1/N2 values, N sets of K1/K2 tables may be configured via RRC signaling, and one or more MAC-CEs may signal or otherwise indicate the set(s) to be used for communication between the UE 115-a and the network entity 105.

In some examples, the UE 115-a may apply the one or more differential offsets after transmitting the control message 225. For example, if the UE 115-a indicates the one or more differential offsets via UCI, the UE 115-a may apply the one or more differential offsets directly (e.g., immediately or approximately immediately, such as within a relatively short time duration) after transmission of the UCI.

The UE 115-a may receive the downlink message 220 from the network entity 105 via the downlink communication link 210-a and, in use cases associated with cooperative reception, via the cooperation information 215 associated with the downlink message 220 from the UE 115-b via the cooperation link 205. The UE 115-a may transmit feedback associated with the downlink message 220 according to the one or more differential offsets. That is, the UE 115-a may apply an extension to a PDSCH processing time, a PUSCH preparation time, or both and may communicate with the network entity 105 in accordance with applying the extension(s) to the PDSCH processing time, the PUSCH preparation time, or both.

FIGS. 3A, 3B, and 3C show examples of timing diagrams 300 that support differential offsets for cooperative reception between multiple UEs in accordance with one or more aspects of the present disclosure. The timing diagrams 300 may implement or be implemented by various aspects of the wireless communication system 100, the wireless communication system 200, or both. For example, the timing diagrams 300 may be implemented by a network entity and a UE, which may represent examples of corresponding devices as illustrated by and described with reference to FIGS. 1 and 2. A UE, which may be an example of an anchor UE in communication with a network entity and a companion UE in a wireless communication system supporting cooperative reception, may apply a differential offset to a PDSCH processing time.

In the example of FIG. 3A, the UE and the network entity may exchange signals according to a timing diagram 300-a including a first slot duration 305-a and a second slot duration 305-b. The first slot duration 305-a may denote a first quantity of slots between a first slot 310-a in which a DCI 315 is communicated (e.g., transmitted by the network entity to the UE) and a second slot 310-b in which a PDSCH 320 is communicated (e.g., transmitted by the network entity to the UE). The second slot duration 305-b may denote a second quantity of slots between the second slot 310-b in which the PDSCH 320 is communicated and a third slot 310-c in which a PUCCH containing ACK/NACK 325 is communicated (e.g., transmitted by the UE to the network entity).

FIG. 3B may be an example of a timing diagram 300-b including symbol durations in which the PDSCH 320 and a PUCCH 330 including the ACK/NACK 325 are communicated. For example, the network entity may transmit the PDSCH 320 in a first set of symbols 335-a, and the UE may transmit the PUCCH 330 in a second set of symbols 335-b, where the PDSCH 320 and the PUCCH 330 are separated by a first symbol duration 345. In other words, the first symbol duration 345 may separate a last symbol of the PDSCH 320 from a first symbol of the PUCCH 330.

The UE may process the PDSCH 320 over a processing time 340 (e.g., N1). For example, the processing time 340 may be associated with an amount of time over which the UE may process the PDSCH 320, and, in some examples, an amount of time for a companion UE to at least partially process the PDSCH 320 and relay a partially processed result to the anchor UE (e.g., for cooperative reception). For example, the companion UE may generate I/Q samples, LLR values, or forward TBs.

Cooperative reception may be associated with processing delays at the anchor UE, the companion UE or both. That is, there may be a processing delay associated with the companion UE partially processing the PDSCH on behalf of the anchor UE. As such, the UE may transmit a control message indicating a differential offset to be added to the processing time 340. For example, the differential offset may be indicated in a unit of symbols to be added to the processing time 340.

The network entity may determine (e.g., calculate or re-calculate) the second slot duration 305-b based on receiving the indication of the differential offset. That is, the network entity may configure the second slot duration 305-b to allow for adequate processing time at the UE considering the differential offset. For example, the network entity may configure the second slot duration 305-b to include a quantity of slots having a time duration greater than at least a time duration associated with the quantity of slots for the processing time 340 and the differential offset.

In the example of FIG. 3C, the UE and the network entity may communicate according to a timing diagram 300-c in which the UE may transmit a UCI skipping indication. For example, after the UE indicates the differential offset(s) (e.g., for PDSCH processing, PUSCH preparation, or both), the network entity may indicate a pair of slot offsets. For example, the pair of slot offsets may include a first slot offset (e.g., K1) between a PDSCH and a PUCCH and a second slot offset (e.g., K2) between a DCI and a PUSCH. Additionally, or alternatively, the network entity may indicate corresponding PUCCH resource indicators (PRIs) (e.g., via the DCI 315). For example, the network entity may indicate a first PUCCH resource in a slot 310-d and a second PUCCH resource in a slot 310-e via the PRIs.

In some examples, the network entity may detect feedback (e.g., ACK/NACK) in a first resource (e.g., in the slot 310-d) and determine that a second resource (e.g., a subsequent resource in the slot 310-e) is released by the UE. That is, the network entity may reallocate (e.g., recycle) the second resource to another UE based on determining that the second resource is released by the UE (e.g., if there is sufficient time between the first resource and the second resource).

In some other examples, the UE may indicate via the UCI skipping indication 350 in the slot 310-d and via a first PUCCH that the second resource (e.g., in the slot 310-e) will not be used. In other words, the UE may indicate via the UCI skipping indication 350 that a subsequent resource in time will not be used (e.g., is released) by the UE.

Additionally, or alternatively, if the network entity does not detect feedback or the UCI skipping indication 350 in a first resource, the network entity may assume that the second resource will be used (e.g., and refrain from releasing the second resource). In other words, if the network entity does not receive feedback and/or the UCI skipping indication 350 in the slot 310-d corresponding to the first resource, the network entity may expect a PUCCH in the slot 310-e corresponding to the second resource.

In some examples, the network entity may configure (e.g., via a RRC message, MAC-CE message, etc.) an offset between PUCCH occasions. For example, the network entity may indicate the offset to the UE such that the UE may determine the second PUCCH by adding the offset from the location of the first PUCCH. That is, the UE may receive an indication of a third slot duration 305-c separating the PDSCH and the first PUCCH and the offset. The UE may add the offset to the third slot duration 305-c to determine a fourth slot duration 305-d separating the PDSCH and the second PUCCH.

FIGS. 4A and 4B show examples of a timing diagrams 400 that supports differential offsets for cooperative reception between multiple UEs in accordance with one or more aspects of the present disclosure. The timing diagrams 400 may implement or be implemented by various aspects of the wireless communication system 100, the wireless communication system 200, or both. For example, the timing diagrams 400 may be implemented by a network entity and a UE, which may represent examples of corresponding devices as illustrated by and described with reference to FIGS. 1 and 2. A UE, which may be an example of an anchor UE in communication with a network entity and a companion UE in a wireless communication system supporting cooperative reception, may apply a differential offset to a PUSCH preparation time.

In the example of FIG. 4A, the UE and the network entity may exchange signals according to a timing diagram 400-a including a slot duration 405. The slot duration 405 may denote a quantity of slots between a first slot 410-a in which a DCI 415 is communicated (e.g., transmitted by the network entity to the UE) and a second slot 410-b in which a PUSCH 420 is communicated (e.g., transmitted by the network entity to the UE).

In some examples, the DCI 415 may configure the UE with multiple slot duration values, allowing the UE to choose one of the multiple slot duration values to apply to the timing diagram. In other words, the DCI 415 may schedule the UE with multiple downlink grant (DG)-PUSCH opportunities. The UE may choose (e.g., select) one or more of the scheduled DG-PUSCH opportunities and/or skip one or more of the scheduled DG-PUSCH opportunities. In some examples, the UE may choose the one or more DG-PUSCH opportunities based on selecting a slot duration.

FIG. 4B may be an example of a timing diagram 400-b including symbol durations in which the DCI 415 and the PUSCH 420 are communicated. For example, the network entity may transmit the DCI 415 in a first set of symbols 425-a, and the UE may transmit the PUSCH 420 in a second set of symbols 425-b, where the DCI 415 and the PUSCH 420 are separated by a symbol duration 445. In other words, the symbol duration 445 may separate a last symbol of the DCI 415 from a first symbol of the PUSCH 420.

The UE may prepare the PUSCH 420 over a preparation time 440 (e.g., N2). For example, the preparation time 440 may be associated with an amount of time over which the UE may prepare the PUSCH 420, and, in some examples, an amount of time for a companion UE to relay information to the anchor UE (e.g., for cooperative reception).

Cooperative reception may be associated with delays at the anchor UE, the companion UE or both. That is, there may be a delay associated with the companion UE forwarding the information to the anchor UE. As such, the UE may transmit a control message indicating a differential offset to be added to the preparation time 440. For example, the differential offset may be indicated in a unit of symbols to be added to the preparation time 440.

The network entity may determine (e.g., calculate or re-calculate) the slot duration 405 based on receiving the indication of the differential offset. That is, the network entity may configure the slot duration 405 to allow for adequate preparation time at the UE considering the differential offset. For example, the network entity may configure the slot duration 405 to include a quantity of slots having a time duration greater than at least a time duration associated with the quantity of slots for the preparation time 440 and the differential offset.

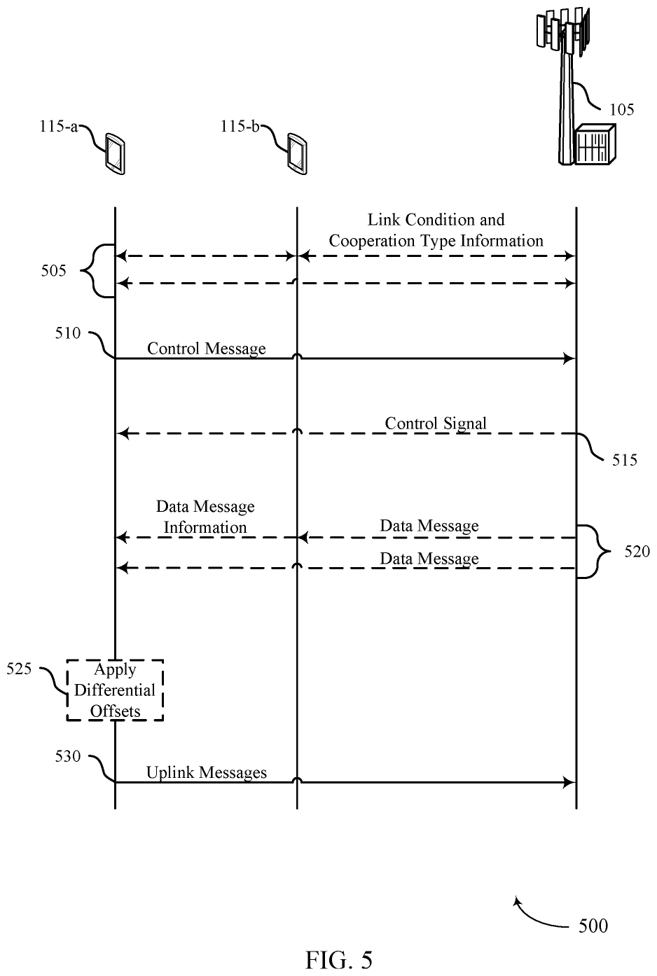

FIG. 5 shows an example of a process flow 500 that supports differential offsets for cooperative reception between multiple UEs in accordance with one or more aspects of the present disclosure. In some examples, the process flow 500 may implement or be implemented by aspects of the wireless communication system 100, the wireless communication system 200, the timing diagrams 300-a, 300-b, 300-c, 400-a, and 400-b as described with reference to FIGS. 1-4B. For example, the process flow 500 may include a UE 115-a, a UE 115-b, and a network entity 105, which may be examples of corresponding devices as illustrated by and described with reference to FIGS. 1 and 2.

Alternative examples of the following may be implemented. Some steps are performed in a different order than described or are not performed at all. In some cases, steps may include additional features not mentioned below, or further steps may be added. Although the UE 115-a, the UE 115-b, and the network entity 105 are shown performing the operations of the process flow 500, some aspects of some operations may also be performed by one or more other wireless communication devices (such as by multiple network entities 105, or in accordance with coordination among multiple network entities 105).

The UE 115-a, which may be an example of an anchor UE in communication with the network entity 105 and the UE 115-b, which may be a companion UE, in a wireless communication system supporting cooperative reception, may apply one or more differential offsets to PDSCH processing, PUSCH preparation, or both.

At 505, the UE 115-a, the UE 115-b, and the network entity 105 may communicate link condition and cooperation type information. For example, the UE 115-a, the UE 115-b, and the network entity 105 may communicate information associated with the link condition between the UE 115-a and the UE 115-b. A link between the UE 115-a and the UE 115-b may be a sidelink communication link supporting cooperative reception. Additionally, or alternatively, the UE 115-a, the UE 115-b, and the network entity 105 may communicate information associated with a type of cooperation between the UE 115-a and the second UE 115-b. For example, the type of cooperation may involve forwarding I/Q samples, LLR values, or TBs.

At 510, the UE 115-a may transmit a control message to the network entity 105 indicating one or more differential offsets. The one or more differential offsets may be applied to a first time duration to process a PDSCH transmission at the UE 115-a, a second time duration to prepare a PUSCH transmission at the UE 115-a, or both. In some examples, the one or more differential offsets may be based on the link condition or type of cooperation communicated at 505.

The UE 115-a may transmit the control message based on a summation of a first quantity of antennas of the UE 115-a and a second quantity of antennas of the UE 115-b satisfying a threshold quantity of antennas. For example, the UE 115-a and the UE 115-b may use the cooperative reception based on the summation satisfying the threshold. In other words, the UE 115-a may determine to use the cooperative reception based on the summation satisfying the threshold, where cooperative reception may support a targeted level of, for example, MIMO gain. That is, the UE 115-a may use cooperative reception to increase MIMO gain when the first quantity of antennas at the UE 115-a is relatively low or few.

In some examples, the control message may include an indication of a first differential offset and a second differential offset. In other words, the one or more differential offsets may include the first differential offset and the second differential offset, where the first differential offset may be applied to the first time duration to process the PDSCH, and where the second differential offset may be applied to the second time duration to prepare the PUSCH.

Additionally, or alternatively, the control message may indicate multiple offset pairs. For example, an offset pair of the multiple offset pairs may include the first differential offset and the second differential offset. That is, each pair may include an offset to be applied for PDSCH processing and an offset to be applied for PUSCH preparation. In some examples, the UE 115-a may transmit a UCI indicating which offset pair of the multiple offset pairs is to be applied. In other words, the UE 115-a may indicate, to the network entity 105, which offset pair indicated in the control message transmitted at 510 will be used.

Additionally, or alternatively, the control message may include a MAC-CE message. Or, in some other examples, the UE 115-a may transmit the control message via a configured uplink grant. That is, the UE 115-a may receive an indication of a configured uplink grant via which to transmit the control message. In some other examples, the UE 115-a may transmit a request for uplink resources via which to transmit the control message and receive an allocation of the uplink resources.

At 515, the network entity 105 may transmit a control signal to the UE 115-a. For example, the control signal may indicate a first slot offset between reception of a PDSCH at the UE 115-a and transmission of feedback by the UE 115-a. Additionally, or alternatively, the control signal may indicate a second slot offset between reception of a downlink control message (e.g., a DCI message) and transmission of uplink data. The first slot offset, the second slot offset, or both may be based on the one or more differential offsets. That is, the network entity 105 may configure the UE 115-a with the first slot offset and the second slot offset based on receiving the control message at 510 indicating the one or more differential offsets.

In some examples, the control signal may indicate multiple slot offset pairs and multiple PRIs corresponding to the multiple slot offset pairs. The UE 115-a may select a PRI of the multiple PRIs in accordance with the one or more differential offsets. For example, a first slot offset pair of the multiple slot offset pairs may include a first slot offset between PDSCH reception and feedback transmission at the UE 115-a and a second slot offset between downlink control message reception and uplink data transmission at the UE 115-a. A second slot offset pair of the multiple slot offset pairs may include a third slot offset between PDSCH reception and feedback transmission at the UE 115-a and a fourth slot offset between downlink control message reception and uplink data transmission at the UE 115-a. That is, each slot offset pair may include a slot offset between PDSCH reception and feedback (e.g., via a PUCCH) transmission (e.g., K1) and a slot offset between downlink control message (e.g., DCI) reception and uplink data (e.g., PUSCH) transmission (e.g., K2). The PRIs may correspond to the first slot offset and the third slot offset. That is, the PRIs may correspond to slot offsets between the PDSCH reception and feedback transmission (e.g., K1s). For example, a first PRI may correspond to the first slot offset and a second PRI may correspond to the third slot offset.

At 520, the network entity 105 may transmit a data message to the UE 115-a via one or multiple paths (depending on whether a use case is associated with a cooperative reception at the UE 115-a). For example, the network entity 105 may transmit the data message to the UE 115-a via a first, direct path including a downlink communication link and, in use cases associated with cooperative reception, via a second, indirect path including a downlink communication link to the UE 115-b and a sidelink communication link between the UE 115-b and the UE 115-a. That is, the UE 115-a may receive information associated with the data message from both the network entity 105 via the downlink communication link and the UE 115-b via the sidelink communication link in association with a cooperative reception between the UE 115-a and the UE 115-b.

For example, the UE 115-a may receive the data message from the network entity 105 and I/Q samples associated with the data message from the UE 115-b for I/Q forwarding. The UE 115-b may partially process the data message in accordance with the I/Q forwarding and transmit the I/Q samples resulting from the partial processing to the UE 115-a.

Additionally, or alternatively, the UE 115-a may receive the data message from the network entity 105 and LLR values associated with the data message from the UE 115-b for LLR value forwarding. The UE 115-b may partially process the data message in accordance with the LLR forwarding and transmit the LLR values resulting from the partial processing to the UE 115-a.

In some examples, the UE 115-a may receive a first TB associated with the data message from the network entity 105 and a second TB associated with the data message from the UE 115-b for TB forwarding. For example, the first TB and the second TB may each include the data message.

At 525, the UE 115-a may apply the one or more differential offsets. For example, the UE 115-a may apply the one or more differential offsets after receiving a DCI message from the network entity 105 and after transmitting the control message at 510. In some examples, the DCI may indicate a HARQ identifier corresponding to a HARQ identifier associated with the control message. For example, the UE 115-a may indicate the one or more differential offsets via a MAC-CE including a same HARQ identifier as the DCI received from the network entity 105.

Additionally, or alternatively, the UE 115-a may apply the one or more differential offsets based on receiving a response to the control message. That is, the UE 115-a may receive a response to the control message transmitted at 510 from the network entity 105 indicating that the network entity received the indication of the one or more differential offsets, and the UE 115-a may apply the one or more differential offsets based on receiving the response.

In some other examples, the UE 115-a may apply the one or more differential offsets after transmitting the control message at 510. For example, the UE 115-a may apply the one or more differential offsets after transmitting the control message as a UCI message. In other words, the UE 115-a may apply the one or more differential offsets directly after transmitting the control message.

At 530, the UE 115-a may transmit one or more uplink messages to the network entity 105. For example, the UE 115-a may transmit the one or more uplink messages based on the one or more differential offsets. In some examples, the one or more uplink messages may include feedback (e.g., ACK/NACK feedback), where the feedback is associated with receiving the information associated with the data message at 520. In some other examples, the one or more uplink messages may be PUSCH messages.

Additionally, or alternatively, the UE 115-a may transmit the one or more uplink messages via an uplink transmission occasion. For example, the UE 115-a may receive an RRC message or a MAC-CE message configuring an offset between a first uplink transmission occasion and a second uplink transmission occasion. The UE 115-a may transmit an uplink message of the one or more uplink messages via one of the first uplink transmission occasion and the second uplink transmission occasion based on the one or more differential offsets.

In some examples, the UE 115-a may transmit the one or more uplink messages via scheduled PUSCH occasions. For example, the UE 115-a may receive a DCI scheduling multiple PUSCH occasions, where each PUSCH occasion is associated with a respective slot offset between downlink message reception and uplink data transmission.

FIG. 6 shows an example of a process flow 600 that supports differential offsets for cooperative reception between multiple UEs in accordance with one or more aspects of the present disclosure. In some examples, the process flow 500 may implement or be implemented by aspects of the wireless communication system 100, the wireless communication system 200, the timing diagrams 300-a, 300-b, 300-c, 400-a, and 400-b as described with reference to FIGS. 1-4B. For example, the process flow 500 may include a UE 115-a, a UE 115-b, and a network entity 105, which may be examples of corresponding devices as illustrated by and described with reference to FIGS. 1 and 2.

Alternative examples of the following may be implemented. Some steps are performed in a different order than described or are not performed at all. In some cases, steps may include additional features not mentioned below, or further steps may be added. Although the UE 115-a, the UE 115-b, and the network entity 105 are shown performing the operations of the process flow 500, some aspects of some operations may also be performed by one or more other wireless communication devices (such as by multiple network entities 105, or in accordance with coordination among multiple network entities 105).

The UE 115-b, which may be an example of an anchor UE in communication with the network entity 105 and the UE 115-a, which may be a companion UE, in a wireless communication system supporting cooperative reception, may apply one or more differential offsets to PDSCH processing, PUSCH preparation, or both. The UE 115-a may perform TB forwarding, with separate TBs, to the UE 115-b.

At 605 and 610, respectively, the network entity 105 may transmit a first channel state information-reference signal (CSI-RS) to the UE 115-b and a second CSI-RS to the UE 115-a. The UE 115-b and the UE 115-a may respond to the CSI-RSs at 615 and 620, respectively, with a first CSI report and a second CSI report. In some examples, the second CSI report may be time division multiplexed.

At 625 and 630, respectively, the network entity 105 may transmit a first DCI to the UE 115-b and a second DCI to the UE 115-a.

At 635 and 640, respectively, the network entity 105 may transmit a first PDSCH to the UE 115-b and a second PDSCH to the UE 115-a. The first PDSCH may include a first TB while the second PSDCH may include a second TB.

At 645 and 650, respectively, the UE 115-b and the UE 115-a may transmit first HARQ-ACK and second HARQ-ACK to the network entity 105. In some examples, the second HARQ-ACK may be time division multiplexed.

At 655, the UE 115-a may forward a transport block to the UE 115-b. For example, the transport block may be the second transport block.

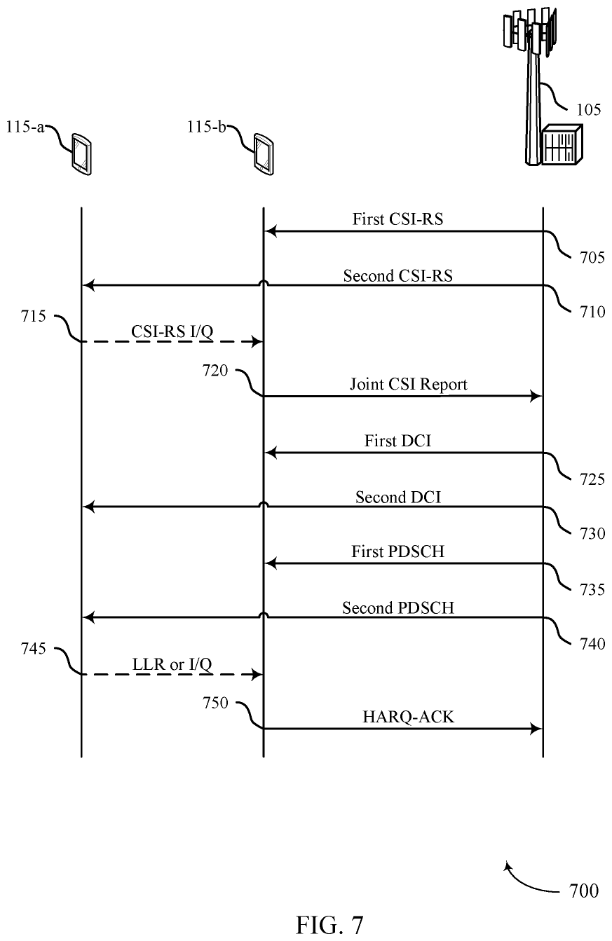

FIG. 7 shows an example of a process flow 700 that supports differential offsets for cooperative reception between multiple UEs in accordance with one or more aspects of the present disclosure. In some examples, the process flow 500 may implement or be implemented by aspects of the wireless communication system 100, the wireless communication system 200, the timing diagrams 300-a, 300-b, 300-c, 400-a, and 400-b as described with reference to FIGS. 1-4B. For example, the process flow 500 may include a UE 115-a, a UE 115-b, and a network entity 105, which may be examples of corresponding devices as illustrated by and described with reference to FIGS. 1 and 2.

Alternative examples of the following may be implemented. Some steps are performed in a different order than described or are not performed at all. In some cases, steps may include additional features not mentioned below, or further steps may be added. Although the UE 115-a, the UE 115-b, and the network entity 105 are shown performing the operations of the process flow 500, some aspects of some operations may also be performed by one or more other wireless communication devices (such as by multiple network entities 105, or in accordance with coordination among multiple network entities 105).

The UE 115-b, which may be an example of an anchor UE in communication with the network entity 105 and the UE 115-a, which may be a companion UE, in a wireless communication system supporting cooperative reception, may apply one or more differential offsets to PDSCH processing, PUSCH preparation, or both. The UE 115-a may perform LLR value and/or IQ sample forwarding to the UE 115-b.

At 705 and 710, respectively, the network entity 105 may transmit a first CSI-RS to the UE 115-b and a second CSI-RS to the UE 115-a. The UE 115-a may, after receiving the second CSI-RS, generate I/Q samples. At 715, the UE 115-a may forward the CSI-RS I/Q samples to the UE 115-b. At 720, the UE 115-b may transmit a joint CSI report.

At 725 and 730, respectively, the network entity 105 may transmit a first DCI to the UE 115-b and a second DCI to the UE 115-a. The first DCI, the second DCI, or both may include PDCCH repetition.

At 735 and 740, respectively, the network entity 105 may transmit a first PDSCH to the UE 115-b and a second PDSCH to the UE 115-a. The first PDSCH, the second PDSCH, or both may be spatial division multiplexed.

At 745, the UE 115-a may transmit LLR values or I/Q samples to the UE 115-b. For example, the UE 115-a may generate the LLR values or the I/Q samples based on receiving the second PDSCH at 740.

At 750, the UE 115-b may transmit a HARQ-ACK to the network entity 105.

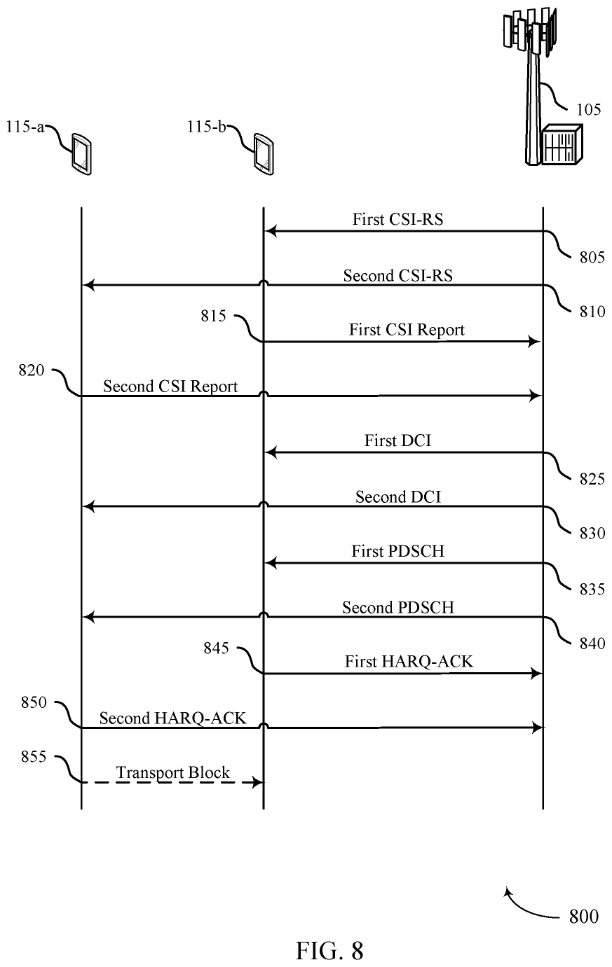

FIG. 8 shows an example of a process flow 800 that supports differential offsets for cooperative reception between multiple UEs in accordance with one or more aspects of the present disclosure. In some examples, the process flow 500 may implement or be implemented by aspects of the wireless communication system 100, the wireless communication system 200, the timing diagrams 300-a, 300-b, 300-c, 400-a, and 400-b as described with reference to FIGS. 1-4B. For example, the process flow 500 may include a UE 115-a, a UE 115-b, and a network entity 105, which may be examples of corresponding devices as illustrated by and described with reference to FIGS. 1 and 2.

Alternative examples of the following may be implemented. Some steps are performed in a different order than described or are not performed at all. In some cases, steps may include additional features not mentioned below, or further steps may be added. Although the UE 115-a, the UE 115-b, and the network entity 105 are shown performing the operations of the process flow 500, some aspects of some operations may also be performed by one or more other wireless communication devices (such as by multiple network entities 105, or in accordance with coordination among multiple network entities 105).

The UE 115-b, which may be an example of an anchor UE in communication with the network entity 105 and the UE 115-a, which may be a companion UE, in a wireless communication system supporting cooperative reception, may apply one or more differential offsets to PDSCH processing, PUSCH preparation, or both. The UE 115-a may perform TB forwarding, with a same TB (e.g., one PDSCH), to the UE 115-b.

At 805 and 810, respectively, the network entity 105 may transmit a first CSI-RS to the UE 115-b and a second CSI-RS to the UE 115-a. The UE 115-b and the UE 115-a may respond to the CSI-RSs at 815 and 820, respectively, with a first CSI report and a second CSI report. In some examples, the second CSI report may be time division multiplexed.

At 825 and 830, respectively, the network entity 105 may transmit a first DCI to the UE 115-b and a second DCI to the UE 115-a. In some examples, the first DCI, the second DCI, or both may include PDCCH repetition.

At 835 and 840, respectively, the network entity 105 may transmit a first PDSCH to the UE 115-b and a second PDSCH to the UE 115-a. The first PDSCH and the second PDSC may each include a first TB. In some examples, the first PDSCH and the second PDSCH may be spatial division multiplexed. In other words, the first PDSCH and the second PDSCH may be a same, single PDSCH, with separate decoding at both UEs 115.

At 845 and 850, respectively, the UE 115-b and the UE 115-a may transmit first HARQ-ACK and second HARQ-ACK to the network entity 105. In some examples, the second HARQ-ACK may be time division multiplexed.

At 855, the UE 115-a may forward the first TB to the UE 115-b. In some examples, the UE 115-b may wait for the forwarded TB from the UE 115-a before transmitting HARQ-ACK feedback for the forwarded TB.

FIG. 9 shows an example of a split stack diagram 900 that supports differential offsets for cooperative reception between multiple UEs in accordance with one or more aspects of the present disclosure. In some examples, the split stack diagram 900 may implement or be implemented by aspects of the wireless communication system 100, the wireless communication system 200, the timing diagrams 300-a, 300-b, 300-c, 400-a, and 400-b as described with reference to FIGS. 1-4B. For example, the split stack diagram 900 may include a UE 115-a, a UE 115-b, and a network entity 105, which may be examples of corresponding devices as illustrated by and described with reference to FIGS. 1 and 2.

The UE 115-a may be a companion UE (e.g., helper UE, relay UE, etc.) to the UE 115-b, which may be an anchor UE or a target UE. For example, the UE 115-a may perform partial processing on a data signal intended for the UE 115-b and forward a result of the partial processing, or the data signal itself, to the UE 115-b. In some examples, the UE 115-a may perform the partial processing and/or forward the data signal based on the UE 115-a, the UE 115-b, or both having a reduced quantity of antennas (e.g., below a threshold). The network entity 105 and the UE 115-a or the UE 115-a may communicate via a communication link (e.g., a Uu link, 5G NR link) while the UE 115-a and the UE 115-b may communicate via a sidelink communication link (e.g., a cooperative link).

The network entity 105 and the UE 115-b may each be associated with multiple protocol layers of a user plane protocol stack. For example, the user plane protocol stack may include an SDAP layer, a PDCP layer, an RLC layer, a MAC layer, and a PHY layer. That is, the UE 115-b may implement a full protocol layer stack. The UE 115-b may perform data processing of higher layers (e.g., SDAP, PDCP, RLC, MAC).

The UE 115-a may perform data processing of the PHY layer. For example, the UE 115-a may perform the data processing for a low PHY layer, a high PHY layer, or both. After performing the processing for the PHY layer, the UE 115-a may forward the partially processed data signal to the UE 115-b, which may perform data processing for the higher layers.

The UE 115-a may perform a fast Fourier transform (FFT) 905, demodulation 910, or decoding 915 according to a type of forwarding. For example, the UE 115-a may perform the FFT 905 on the data signal to generate I/Q samples and forward the I/Q samples to the UE 115-b. Or, the UE 115-a may perform the FFT 905 and the demodulation 910 to generate LLR values and forward the LLR values to the UE 115-b. Additionally, or alternatively, the UE 115-a may perform the FFT 905, the demodulation 910, and the decoding 915 to generate a TB and forward the TB to the UE 115-b. In some examples, performing the FFT 905 and/or the demodulation 910 may be a low PHY split option while performing the FFT 905, demodulation 910, and decoding 915 may be a high PHY split option. In other words, the UE 115-a may perform partial processing according to the low PHY split or high PHY split and forward an output of the partial processing to the UE 115-b.

In some examples, the low PHY split may be associated with a higher capacity and lower latency on the cooperative link compared to the high PHY split. For example, TB forwarding may be associated with a lowest capacity and highest latency, while I/Q forwarding may be associated with a highest capacity and lowest latency of TB forwarding, LLR forwarding, or I/Q forwarding. In other words, forwarding options which involve a larger quantity of processing steps may be associated with higher latency. In some examples, the UE 115-b may determine one or more differential offsets to be applied to PDSCH processing, PUSCH preparation, or both based on the type of forwarding performed by the UE 115-a. That is, the UE 115-b may consider a latency associated with the type of forwarding and set the one or more differential offsets accordingly.

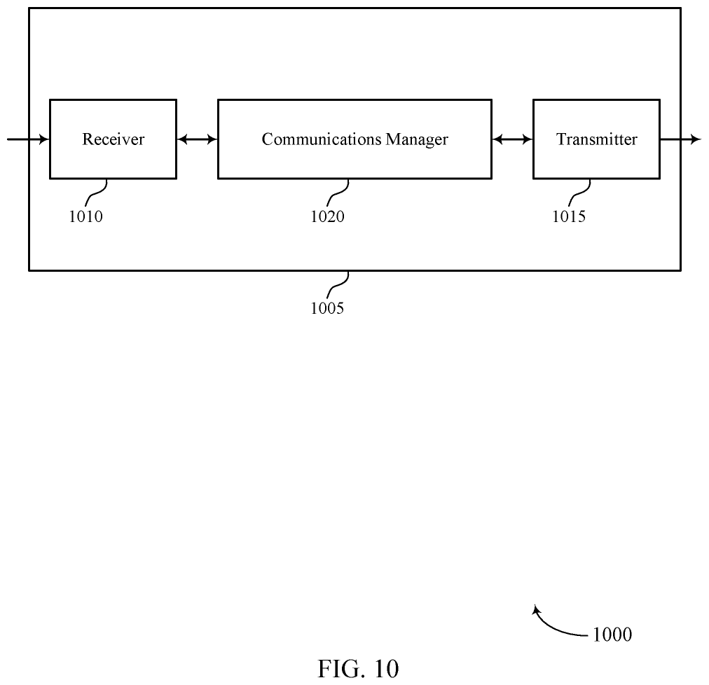

FIG. 10 shows a block diagram 1000 of a device 1005 that supports differential offsets for cooperative reception between multiple UEs in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to differential offsets for cooperative reception between multiple UEs). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to differential offsets for cooperative reception between multiple UEs). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of differential offsets for cooperative reception between multiple UEs as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for transmitting a control message that indicates one or more differential offsets, the one or more differential offsets to be applied to one or both of a first time duration to process an PDSCH transmission at the first UE and a second time duration to prepare an PUSCH transmission at the first UE. The communications manager 1020 is capable of, configured to, or operable to support a means for transmitting one or more uplink messages based on the one or more differential offsets.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

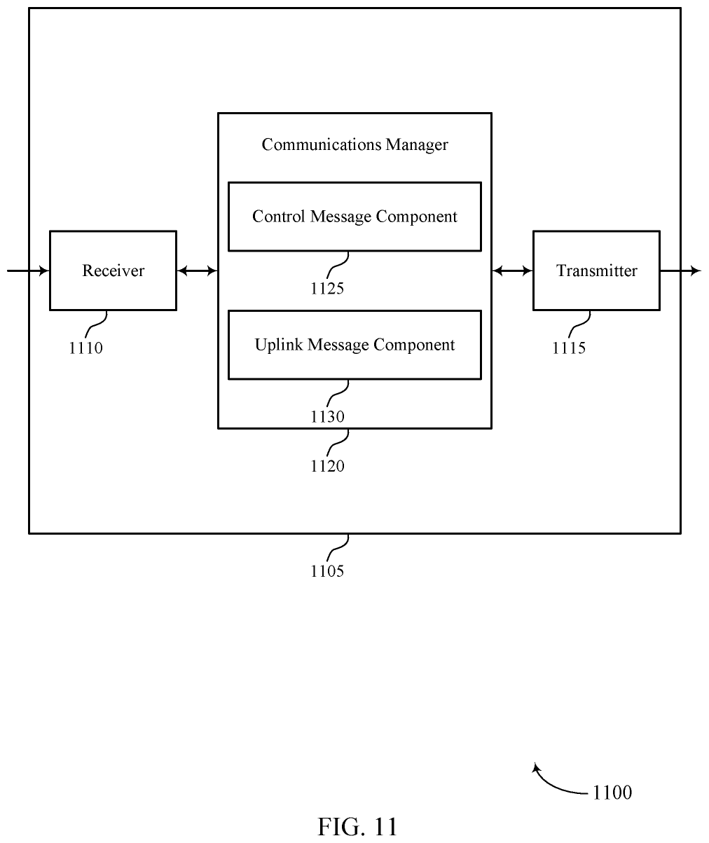

FIG. 11 shows a block diagram 1100 of a device 1105 that supports differential offsets for cooperative reception between multiple UEs in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to differential offsets for cooperative reception between multiple UEs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to differential offsets for cooperative reception between multiple UEs). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of differential offsets for cooperative reception between multiple UEs as described herein. For example, the communications manager 1120 may include a control message component 1125 an uplink message component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The control message component 1125 is capable of, configured to, or operable to support a means for transmitting a control message that indicates one or more differential offsets, the one or more differential offsets to be applied to one or both of a first time duration to process an PDSCH transmission at the first UE and a second time duration to prepare an PUSCH transmission at the first UE. The uplink message component 1130 is capable of, configured to, or operable to support a means for transmitting one or more uplink messages based on the one or more differential offsets.

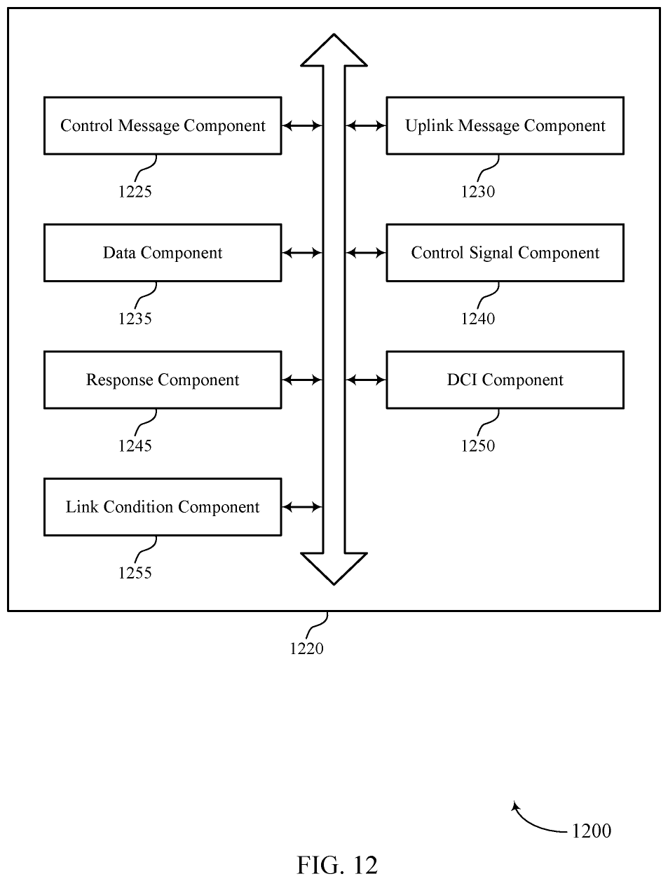

FIG. 12 shows a block diagram 1200 of a communications manager 1220 that supports differential offsets for cooperative reception between multiple UEs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of differential offsets for cooperative reception between multiple UEs as described herein. For example, the communications manager 1220 may include a control message component 1225, an uplink message component 1230, a data component 1235, a control signal component 1240, a response component 1245, a DCI component 1250, a link condition component 1255, or any combination thereof. Each of these components, or components or subcomponents thereof (e.g., one or more processors, one or more memories), may communicate, directly or indirectly, with one another (e.g., via one or more buses).

The communications manager 1220 may support wireless communication in accordance with examples as disclosed herein. The control message component 1225 is capable of, configured to, or operable to support a means for transmitting a control message that indicates one or more differential offsets, the one or more differential offsets to be applied to one or both of a first time duration to process an PDSCH transmission at the first UE and a second time duration to prepare an PUSCH transmission at the first UE. The uplink message component 1230 is capable of, configured to, or operable to support a means for transmitting one or more uplink messages based on the one or more differential offsets.

In some examples, to support transmitting the one or more uplink messages, the uplink message component 1230 is capable of, configured to, or operable to support a means for transmitting one or more PUSCH messages.

In some examples, the DCI component 1250 is capable of, configured to, or operable to support a means for receiving a DCI message scheduling a set of multiple PUSCH occasions, where each respective PUSCH occasion is associated with a respective slot offset between downlink control message reception and uplink data transmission. In some examples, the uplink message component 1230 is capable of, configured to, or operable to support a means for transmitting a PUSCH message of the one or more PUSCH messages via one of the set of multiple PUSCH occasions based on the one or more differential offsets.

In some examples, the data component 1235 is capable of, configured to, or operable to support a means for receiving information associated with a data message from both a network entity via a downlink communication link and a second UE via a sidelink communication link in association with a cooperative reception between the first UE and the second UE. In some examples, the uplink message component 1230 is capable of, configured to, or operable to support a means for transmitting feedback associated with the data message, where the one or more uplink messages include the feedback.

In some examples, the link condition component 1255 is capable of, configured to, or operable to support a means for communicating second information associated with one or both of a link condition between the first UE and the second UE and a type of cooperation between the first UE and the second UE, where the one or more differential offsets are based on one or both of the link condition and the type of cooperation.

In some examples, to support receiving the information associated with the data message, the data component 1235 is capable of, configured to, or operable to support a means for receiving the data message from the network entity and a set of multiple I/Q samples associated with the data message from the second UE, the set of multiple I/Q samples associated with a partial processing of the data message by the second UE in accordance with the type of cooperation.

In some examples, to support receiving the information associated with the data message, the data component 1235 is capable of, configured to, or operable to support a means for receiving the data message from the network entity and a set of multiple LLR values associated with the data message from the second UE, the set of multiple LLR values associated with a partial processing of the data message by the second UE in accordance with the type of cooperation.

In some examples, to support receiving the information associated with the data message, the data component 1235 is capable of, configured to, or operable to support a means for receiving a first TB associated with the data message from the network entity and second TB associated with the data message from the second UE in accordance with the type of cooperation, where the first TB and the second TB each include the data message.

In some examples, the control signal component 1240 is capable of, configured to, or operable to support a means for receiving a control signal that indicates a set of multiple slot offset pairs and a set of multiple PUCCH resource indicators (PRIs) corresponding to the set of multiple slot offset pairs. In some examples, the uplink message component 1230 is capable of, configured to, or operable to support a means for selecting a PRI of the set of multiple PRIs in accordance with at least one of the one or more differential offsets, where the feedback is transmitted via a PUCCH resource corresponding to the selected PRI.

In some examples, a first slot offset pair of the set of multiple slot offset pairs includes a first slot offset between PDSCH reception and feedback transmission and a second slot offset between downlink control message reception and uplink data transmission. In some examples, a second slot offset pair of the set of multiple slot offset pairs includes a third slot offset between PDSCH reception and feedback transmission and a fourth slot offset between downlink control message reception and uplink data transmission. In some examples, a first PRI of the set of multiple PRIs corresponds to the first slot offset. In some examples, a second PRI of the set of multiple PRIs corresponds to the third slot offset.

In some examples, to support receiving the information associated with the data message, the data component 1235 is capable of, configured to, or operable to support a means for receiving the information associated with the data message from both the network entity and the second UE in accordance with a quantity of antennas of the first UE, the quantity of antennas at the first UE being below a threshold quantity of antennas, where the control message that indicates the one or more differential offsets is transmitted based on the quantity of antennas at the first UE being below the threshold quantity.

In some examples, a summation of a first quantity of antennas of the first UE and a second quantity of antennas of the second UE satisfy a threshold quantity of antennas. In some examples, transmitting the control message that indicates the one or more differential offsets is based on the summation of the first quantity of antennas and the second quantity of antennas satisfying the threshold quantity of antennas. In some examples, the cooperative reception between the first UE and the second UE is based on the summation of the first quantity of antennas and the second quantity of antennas of the second UE satisfying the threshold quantity of antennas.

In some examples, to support transmitting the control message, the control message component 1225 is capable of, configured to, or operable to support a means for transmitting an indication of a first differential offset and a second differential offset, where the one or more differential offsets include the first differential offset and the second differential offset, and where the first differential offset is to be applied to the first time duration process the PDSCH transmission at the first UE and the second differential offset is to be applied to the second time duration to prepare the PUSCH transmission at the first UE.

In some examples, the control message further indicates a set of multiple offset pairs, and the control message component 1225 is capable of, configured to, or operable to support a means for transmitting an uplink control information (UCI) message indicating that the first offset pair is to be applied prior to transmitting the one or more uplink messages, where the one or more uplink messages are transmitted based on the UCI message and the first offset pair.

In some examples, the control signal component 1240 is capable of, configured to, or operable to support a means for receiving a control signal that indicates a first slot offset between reception of an PDSCH and transmission of the feedback and that indicates a second slot offset between reception of a downlink control message and transmission of uplink data, where the first slot offset and the second slot offset are based on the one or more differential offsets, and where the one or more uplink messages are transmitted according to at least the first slot offset or the second slot offset.

In some examples, the uplink message component 1230 is capable of, configured to, or operable to support a means for applying the one or more differential offsets based on reception of a DCI message after transmitting the control message, where the one or more uplink messages are transmitted based on applying the one or more differential offsets.

In some examples, the DCI message indicates an HARQ identifier which corresponds to a HARQ identifier associated with the control message.

In some examples, the response component 1245 is capable of, configured to, or operable to support a means for receiving a response to the control message from the network entity. In some examples, the uplink message component 1230 is capable of, configured to, or operable to support a means for applying the one or more differential offsets based on receiving the response, where the one or more uplink messages are transmitted based on applying the one or more differential offsets.

In some examples, the uplink message component 1230 is capable of, configured to, or operable to support a means for applying the one or more differential offsets after transmitting the control message, where the control message includes an uplink control information (UCI) message, and where the one or more uplink messages are transmitted based on applying the one or more differential offsets.

In some examples, to support applying the one or more differential offsets, the uplink message component 1230 is capable of, configured to, or operable to support a means for applying the one or more differential offsets directly after transmitting the control message.

In some examples, the control message includes a medium access control-control element (MAC-CE) message.

In some examples, the control message component 1225 is capable of, configured to, or operable to support a means for receiving an indication of a configured uplink grant via which to transmit the control message that indicates the one or more differential offsets, where the control message is transmitted via the configured uplink grant.

In some examples, the control message component 1225 is capable of, configured to, or operable to support a means for transmitting a request for uplink resources via which to transmit the control message that indicates the one or more differential offsets. In some examples, the control message component 1225 is capable of, configured to, or operable to support a means for receiving an allocation of the uplink resources, where the control message is transmitted via the uplink resources.

In some examples, the control signal component 1240 is capable of, configured to, or operable to support a means for receiving an RRC message or a medium access control-control element (MAC-CE) message configuring an offset between a first uplink transmission occasion and a second uplink transmission occasion. In some examples, the uplink message component 1230 is capable of, configured to, or operable to support a means for transmitting an uplink message of the one or more uplink messages via one of the first uplink transmission occasion and the second uplink transmission occasion based on the one or more differential offsets.

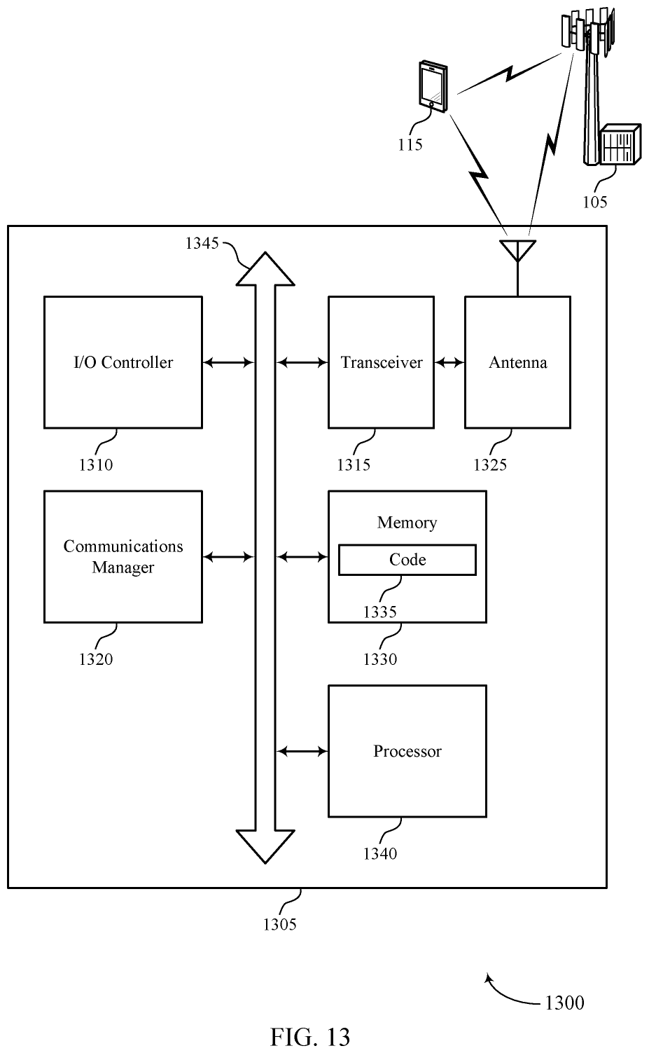

FIG. 13 shows a diagram of a system 1300 including a device 1305 that supports differential offsets for cooperative reception between multiple UEs in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable code 1335 including instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may contain, among other things, a basic I/O system (BIOS) which may control basic hardware or software operation such as the interaction with peripheral components or devices.

The at least one processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting differential offsets for cooperative reception between multiple UEs). For example, the device 1305 or a component of the device 1305 may include at least one processor 1340 and at least one memory 1330 coupled with or to the at least one processor 1340, the at least one processor 1340 and at least one memory 1330 configured to perform various functions described herein. In some examples, the at least one processor 1340 may include multiple processors and the at least one memory 1330 may include multiple memories. One or more of the multiple processors may be coupled with one or more of the multiple memories, which may, individually or collectively, be configured to perform various functions herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1330 or otherwise, to perform one or more of the functions described herein.

The communications manager 1320 may support wireless communication in accordance with examples as disclosed herein. For example, the communications manager 1320 is capable of, configured to, or operable to support a means for transmitting a control message that indicates one or more differential offsets, the one or more differential offsets to be applied to one or both of a first time duration to process an PDSCH transmission at the first UE and a second time duration to prepare an PUSCH transmission at the first UE. The communications manager 1320 is capable of, configured to, or operable to support a means for transmitting one or more uplink messages based on the one or more differential offsets.

By including or configuring the communications manager 1320 in accordance with examples as described herein, the device 1305 may support techniques for improved communication reliability and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of differential offsets for cooperative reception between multiple UEs as described herein, or the at least one processor 1340 and the at least one memory 1330 may be otherwise configured to, individually or collectively, perform or support such operations.

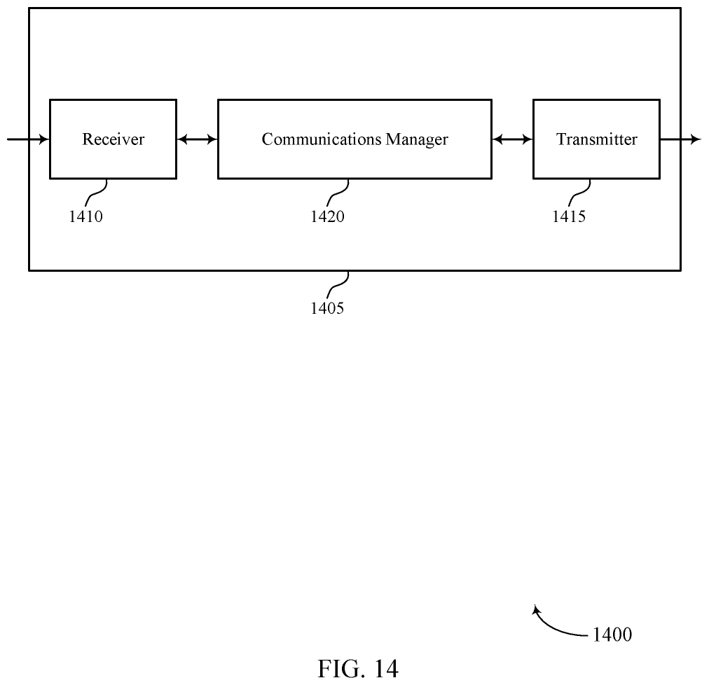

FIG. 14 shows a block diagram 1400 of a device 1405 that supports differential offsets for cooperative reception between multiple UEs in accordance with one or more aspects of the present disclosure. The device 1405 may be an example of aspects of a network entity 105 as described herein. The device 1405 may include a receiver 1410, a transmitter 1415, and a communications manager 1420. The device 1405, or one or more components of the device 1405 (e.g., the receiver 1410, the transmitter 1415, and the communications manager 1420), may include at least one processor, which may be coupled with at least one memory, to, individually or collectively, support or enable the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of differential offsets for cooperative reception between multiple UEs as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor. If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

For example, the communications manager 1420 is capable of, configured to, or operable to support a means for obtaining a control message that indicates one or more differential offsets, the one or more differential offsets to be applied to one or both of a first time duration to process an PDSCH transmission at a first UE and a second time duration to prepare an PUSCH transmission at the first UE. The communications manager 1420 is capable of, configured to, or operable to support a means for obtaining one or more uplink messages based on the one or more differential offsets.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for more efficient utilization of communication resources.

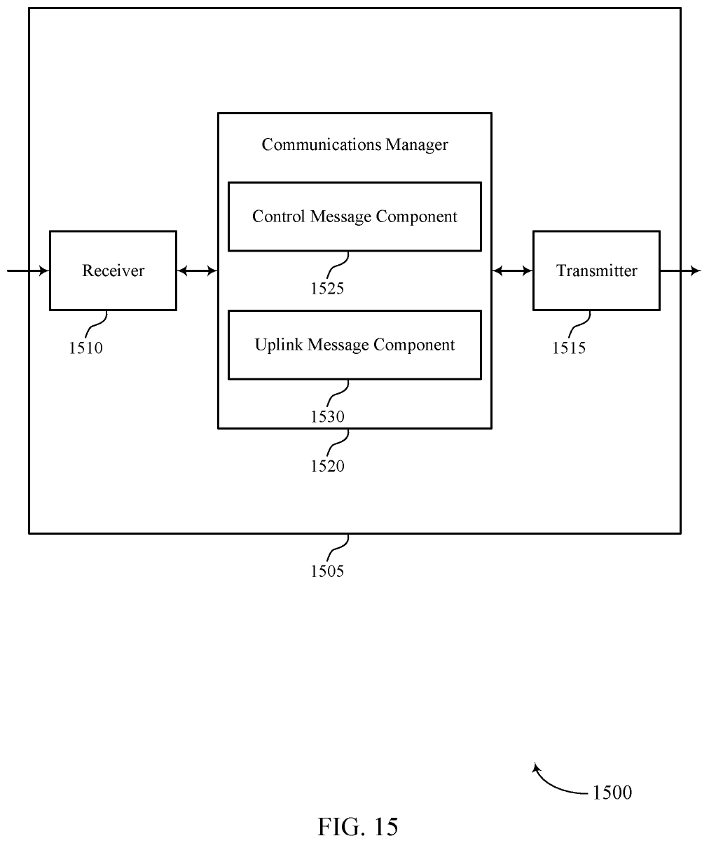

FIG. 15 shows a block diagram 1500 of a device 1505 that supports differential offsets for cooperative reception between multiple UEs in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505, or one or more components of the device 1505 (e.g., the receiver 1510, the transmitter 1515, and the communications manager 1520), may include at least one processor, which may be coupled with at least one memory, to support the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of differential offsets for cooperative reception between multiple UEs as described herein. For example, the communications manager 1520 may include a control message component 1525 an uplink message component 1530, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The control message component 1525 is capable of, configured to, or operable to support a means for obtaining a control message that indicates one or more differential offsets, the one or more differential offsets to be applied to one or both of a first time duration to process an PDSCH transmission at a first UE and a second time duration to prepare an PUSCH transmission at the first UE. The uplink message component 1530 is capable of, configured to, or operable to support a means for obtaining one or more uplink messages based on the one or more differential offsets.

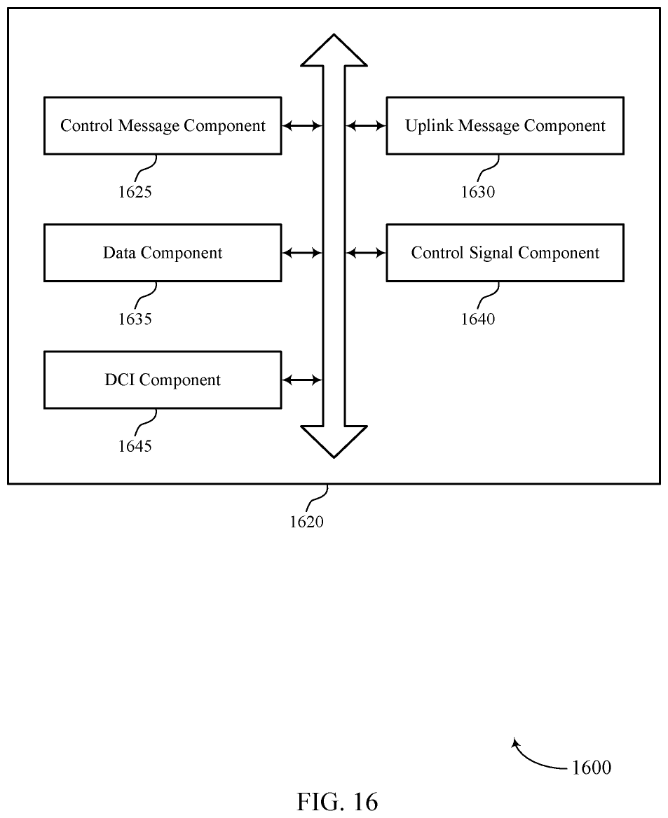

FIG. 16 shows a block diagram 1600 of a communications manager 1620 that supports differential offsets for cooperative reception between multiple UEs in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of differential offsets for cooperative reception between multiple UEs as described herein. For example, the communications manager 1620 may include a control message component 1625, an uplink message component 1630, a data component 1635, a control signal component 1640, a DCI component 1645, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The control message component 1625 is capable of, configured to, or operable to support a means for obtaining a control message that indicates one or more differential offsets, the one or more differential offsets to be applied to one or both of a first time duration to process an PDSCH transmission at a first UE and a second time duration to prepare an PUSCH transmission at the first UE. The uplink message component 1630 is capable of, configured to, or operable to support a means for obtaining one or more uplink messages based on the one or more differential offsets.

In some examples, to support obtaining the one or more uplink messages, the uplink message component 1630 is capable of, configured to, or operable to support a means for obtaining one or more PUSCH messages.

In some examples, the DCI component 1645 is capable of, configured to, or operable to support a means for outputting a DCI message scheduling a set of multiple PUSCH occasions, where each respective PUSCH occasion is associated with a respective slot offset between downlink control message reception and uplink data transmission. In some examples, the uplink message component 1630 is capable of, configured to, or operable to support a means for obtaining a PUSCH message of the one or more PUSCH messages via one of the set of multiple PUSCH occasions based on the one or more differential offsets.

In some examples, the data component 1635 is capable of, configured to, or operable to support a means for obtaining information associated with a data message to the first UE and to a second UE in association with a cooperative reception between the first UE and the second UE. In some examples, the uplink message component 1630 is capable of, configured to, or operable to support a means for obtaining the one or more uplink messages, where the one or more uplink messages include feedback associated with the data message.

In some examples, the control signal component 1640 is capable of, configured to, or operable to support a means for outputting a control signal that indicates a set of multiple slot offset pairs and a set of multiple PUCCH resource indicators (PRIs) corresponding to the set of multiple slot offset pairs, where the feedback is obtained via a PUCCH resource corresponding to a selected PRI of the set of multiple PRIs.

In some examples, a first slot offset pair of the set of multiple slot offset pairs includes a first slot offset between PDSCH transmission and feedback reception and a second slot offset between downlink control message transmission and uplink data reception. In some examples, a second slot offset pair of the set of multiple slot offset pairs includes a third slot offset between PDSCH transmission and feedback reception and a fourth slot offset between downlink control message transmission and uplink data reception. In some examples, a first PRI of the set of multiple PRIs corresponds to the first slot offset. In some examples, a second PRI of the set of multiple PRIs corresponds to the third slot offset.

In some examples, to support receiving the control message, the control message component 1625 is capable of, configured to, or operable to support a means for obtaining an indication of a first differential offset and a second differential offset, where the one or more differential offsets include the first differential offset and the second differential offset, and where the first differential offset is to be applied to the first time duration process the PDSCH transmission at the first UE and the second differential offset is to be applied to the second time duration to prepare the PUSCH transmission at the first UE.

In some examples, the control message further indicates a set of multiple offset pairs, and the uplink message component 1630 is capable of, configured to, or operable to support a means for obtaining an uplink control information (UCI) message indicating that the first offset pair is to be applied prior to obtaining the one or more uplink messages, where the one or more uplink messages are obtained based on the UCI message and the first offset pair.

In some examples, the control signal component 1640 is capable of, configured to, or operable to support a means for outputting a control signal that indicates a first slot offset between transmission of an PDSCH and reception of the feedback and that indicates a second slot offset between transmission of a downlink control message and reception of uplink data, where the first slot offset and the second slot offset are based on the one or more differential offsets, and where the one or more uplink messages are obtained according to at least the first slot offset or the second slot offset.

In some examples, the control message includes a medium access control-control element (MAC-CE) message.

In some examples, the control message component 1625 is capable of, configured to, or operable to support a means for outputting an indication of a configured uplink grant via which to receive the control message that indicates the one or more differential offsets, where the control message is obtained based on the configured uplink grant.

In some examples, the control message component 1625 is capable of, configured to, or operable to support a means for obtaining a request for uplink resources associated with the control message that indicates the one or more differential offsets. In some examples, the control message component 1625 is capable of, configured to, or operable to support a means for outputting an allocation of the uplink resources, where the control message is obtained based on the uplink resources.

In some examples, the control signal component 1640 is capable of, configured to, or operable to support a means for outputting an RRC message or a medium access control-control element (MAC-CE) message configuring an offset between a first uplink transmission occasion and a second uplink transmission occasion. In some examples, the uplink message component 1630 is capable of, configured to, or operable to support a means for obtaining an uplink message of the one or more uplink messages via one of the first uplink transmission occasion and the second uplink transmission occasion based on the one or more differential offsets.

In some examples, to support outputting the data message, the data component 1635 is capable of, configured to, or operable to support a means for outputting the data message to the first UE and the second UE in association with the cooperative reception between the first UE and the second UE in accordance with a quantity of antennas of the first UE, the quantity of antennas at the first UE being below a threshold quantity of antennas, where the control message that indicates the one or more differential offsets is obtained based on the quantity of antennas at the first UE being below the threshold quantity.

In some examples, a summation of a first quantity of antennas of the first UE and a second quantity of antennas of the second UE satisfy a threshold quantity of antennas. In some examples, the control message that indicates the one or more differential offsets is obtained based on the summation of the first quantity of antennas and the second quantity of antennas satisfying the threshold quantity of antennas. In some examples, the cooperative reception between the first UE and the second UE is based on the summation of the first quantity of antennas and the second quantity of antennas of the second UE satisfying the threshold quantity of antennas.

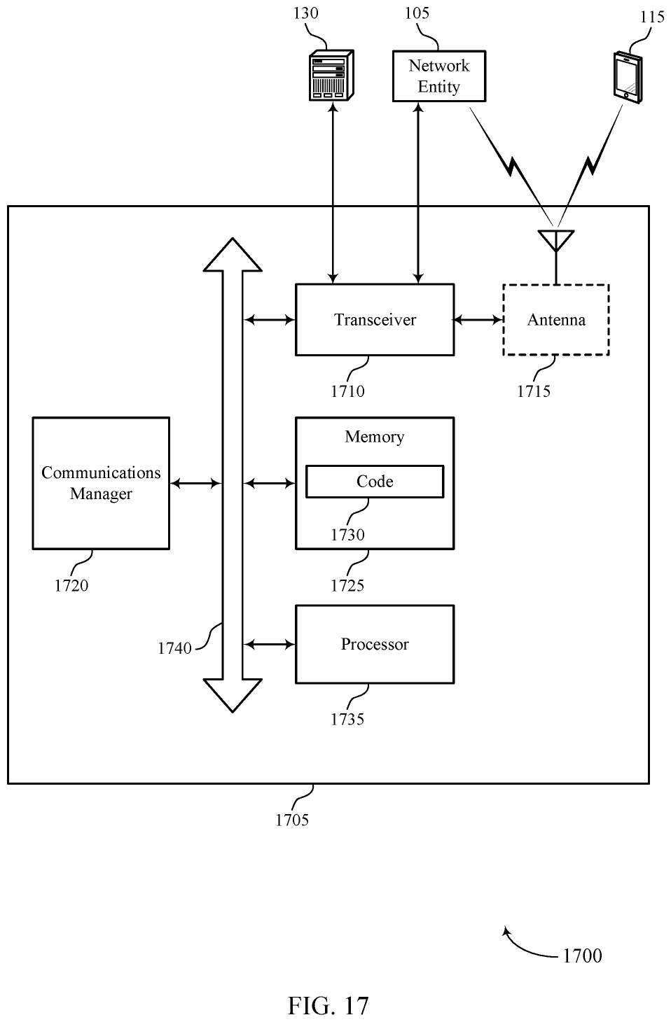

FIG. 17 shows a diagram of a system 1700 including a device 1705 that supports differential offsets for cooperative reception between multiple UEs in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, at least one memory 1725, code 1730, and at least one processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or one or more memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or one or more memory components (e.g., the at least one processor 1735, the at least one memory 1725, or both), may be included in a chip or chip assembly that is installed in the device 1705. In some examples, the transceiver 1710 may be operable to support communications via one or more communications links (e.g., a communication link 125, a backhaul communication link 120, a midhaul communication link 162, a fronthaul communication link 168).

The at least one memory 1725 may include RAM, ROM, or any combination thereof. The at least one memory 1725 may store computer-readable, computer-executable code 1730 including instructions that, when executed by one or more of the at least one processor 1735, cause the device 1705 to perform various functions described herein. The code 1730 may be stored in a non-transitory computer-readable medium such as system memory or another type of memory. In some cases, the code 1730 may not be directly executable by a processor of the at least one processor 1735 but may cause a computer (e.g., when compiled and executed) to perform functions described herein. In some cases, the at least one memory 1725 may contain, among other things, a BIOS which may control basic hardware or software operation such as the interaction with peripheral components or devices. In some examples, the at least one processor 1735 may include multiple processors and the at least one memory 1725 may include multiple memories. One or more of the multiple processors may be coupled with one or more of the multiple memories which may, individually or collectively, be configured to perform various functions herein (for example, as part of a processing system).

The at least one processor 1735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1735 may be configured to operate a memory array using a memory controller. In some other cases, a memory controller may be integrated into one or more of the at least one processor 1735. The at least one processor 1735 may be configured to execute computer-readable instructions stored in a memory (e.g., one or more of the at least one memory 1725) to cause the device 1705 to perform various functions (e.g., functions or tasks supporting differential offsets for cooperative reception between multiple UEs). For example, the device 1705 or a component of the device 1705 may include at least one processor 1735 and at least one memory 1725 coupled with one or more of the at least one processor 1735, the at least one processor 1735 and the at least one memory 1725 configured to perform various functions described herein. The at least one processor 1735 may be an example of a cloud-computing platform (e.g., one or more physical nodes and supporting software such as operating systems, virtual machines, or container instances) that may host the functions (e.g., by executing code 1730) to perform the functions of the device 1705. The at least one processor 1735 may be any one or more suitable processors capable of executing scripts or instructions of one or more software programs stored in the device 1705 (such as within one or more of the at least one memory 1725). In some examples, the at least one processor 1735 may include multiple processors and the at least one memory 1725 may include multiple memories. One or more of the multiple processors may be coupled with one or more of the multiple memories, which may, individually or collectively, be configured to perform various functions herein. In some examples, the at least one processor 1735 may be a component of a processing system, which may refer to a system (such as a series) of machines, circuitry (including, for example, one or both of processor circuitry (which may include the at least one processor 1735) and memory circuitry (which may include the at least one memory 1725)), or components, that receives or obtains inputs and processes the inputs to produce, generate, or obtain a set of outputs. The processing system may be configured to perform one or more of the functions described herein. For example, the at least one processor 1735 or a processing system including the at least one processor 1735 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code stored in the at least one memory 1725 or otherwise, to perform one or more of the functions described herein.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the at least one memory 1725, the code 1730, and the at least one processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

For example, the communications manager 1720 is capable of, configured to, or operable to support a means for obtaining a control message that indicates one or more differential offsets, the one or more differential offsets to be applied to one or both of a first time duration to process an PDSCH transmission at a first UE and a second time duration to prepare an PUSCH transmission at the first UE. The communications manager 1720 is capable of, configured to, or operable to support a means for obtaining one or more uplink messages based on the one or more differential offsets.

By including or configuring the communications manager 1720 in accordance with examples as described herein, the device 1705 may support techniques for improved communication reliability and improved coordination between devices.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, one or more of the at least one processor 1735, one or more of the at least one memory 1725, the code 1730, or any combination thereof (for example, by a processing system including at least a portion of the at least one processor 1735, the at least one memory 1725, the code 1730, or any combination thereof). For example, the code 1730 may include instructions executable by one or more of the at least one processor 1735 to cause the device 1705 to perform various aspects of differential offsets for cooperative reception between multiple UEs as described herein, or the at least one processor 1735 and the at least one memory 1725 may be otherwise configured to, individually or collectively, perform or support such operations.

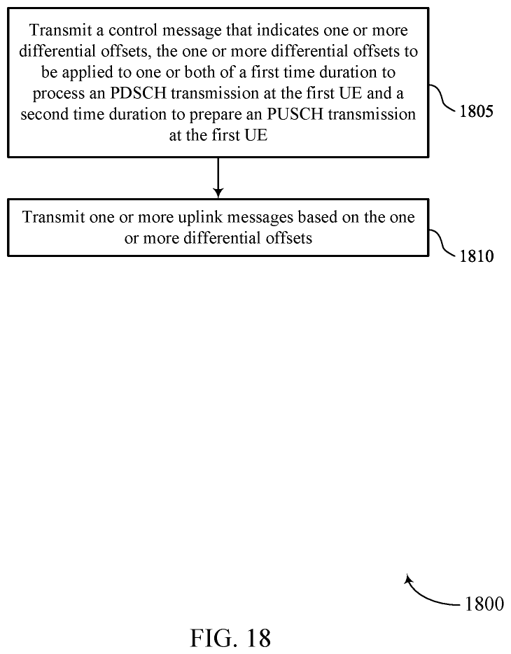

FIG. 18 shows a flowchart illustrating a method 1800 that supports differential offsets for cooperative reception between multiple UEs in accordance with aspects of the present disclosure. The operations of the method 1800 may be implemented by a UE or its components as described herein. For example, the operations of the method 1800 may be performed by a UE 115 as described with reference to FIGS. 1-13. In some examples, a UE may execute a set of instructions to control the functional elements of the UE to perform the described functions. Additionally, or alternatively, the UE may perform aspects of the described functions using special-purpose hardware.

At 1805, the method may include transmitting a control message that indicates one or more differential offsets, the one or more differential offsets to be applied to one or both of a first time duration to process an PDSCH transmission at the first UE and a second time duration to prepare an PUSCH transmission at the first UE. The operations of block 1805 may be performed in accordance with examples as disclosed herein. In some examples, aspects of the operations of 1805 may be performed by a control message component 1225 as described with reference to FIG. 12.

At 1810, the method may include transmitting one or more uplink messages based on the one or more differential offsets. The operations of block 1810 may be performed in accordance with examples as disclosed herein. In some examples, aspects of the operations of 1810 may be performed by an uplink message component 1230 as described with reference to FIG. 12.

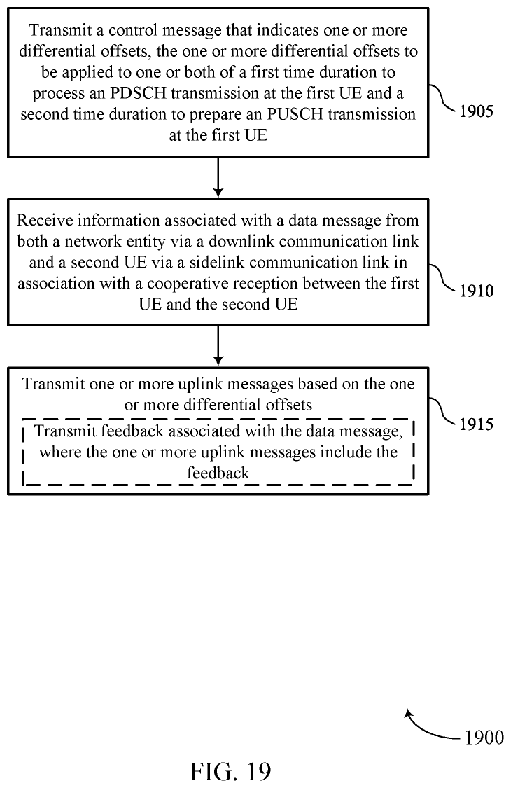

FIG. 19 shows a flowchart illustrating a method 1900 that supports differential offsets for cooperative reception between multiple UEs in accordance with aspects of the present disclosure. The operations of the method 1900 may be implemented by a UE or its components as described herein. For example, the operations of the method 1900 may be performed by a UE 115 as described with reference to FIGS. 1-13. In some examples, a UE may execute a set of instructions to control the functional elements of the UE to perform the described functions. Additionally, or alternatively, the UE may perform aspects of the described functions using special-purpose hardware.

At 1905, the method may include transmitting a control message that indicates one or more differential offsets, the one or more differential offsets to be applied to one or both of a first time duration to process an PDSCH transmission at the first UE and a second time duration to prepare an PUSCH transmission at the first UE. The operations of block 1905 may be performed in accordance with examples as disclosed herein. In some examples, aspects of the operations of 1905 may be performed by a control message component 1225 as described with reference to FIG. 12.

At 1910, the method may include receiving information associated with a data message from both a network entity via a downlink communication link and a second UE via a sidelink communication link in association with a cooperative reception between the first UE and the second UE. The operations of block 1910 may be performed in accordance with examples as disclosed herein. In some examples, aspects of the operations of 1910 may be performed by a data component 1235 as described with reference to FIG. 12.

At 1915, the method may include transmitting one or more uplink messages based on the one or more differential offsets, where the one or more uplink messages include feedback associated with the data message. The operations of block 1915 may be performed in accordance with examples as disclosed herein. In some examples, aspects of the operations of 1915 may be performed by an uplink message component 1230 as described with reference to FIG. 12.

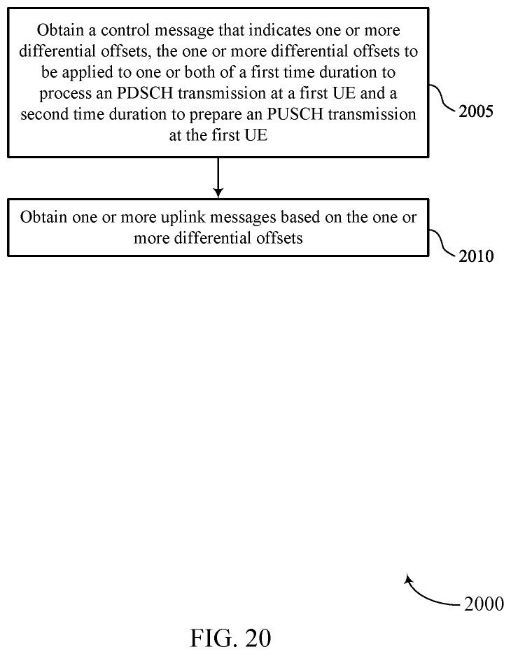

FIG. 20 shows a flowchart illustrating a method 2000 that supports differential offsets for cooperative reception between multiple UEs in accordance with aspects of the present disclosure. The operations of the method 2000 may be implemented by a network entity or its components as described herein. For example, the operations of the method 2000 may be performed by a network entity as described with reference to FIGS. 1-9 and 14-17. In some examples, a network entity may execute a set of instructions to control the functional elements of the network entity to perform the described functions. Additionally, or alternatively, the network entity may perform aspects of the described functions using special-purpose hardware.

At 2005, the method may include obtaining a control message that indicates one or more differential offsets, the one or more differential offsets to be applied to one or both of a first time duration to process an PDSCH transmission at a first UE and a second time duration to prepare an PUSCH transmission at the first UE. The operations of block 2005 may be performed in accordance with examples as disclosed herein. In some examples, aspects of the operations of 2005 may be performed by a control message component 1625 as described with reference to FIG. 16.

At 2010, the method may include obtaining one or more uplink messages based on the one or more differential offsets. The operations of block 2010 may be performed in accordance with examples as disclosed herein. In some examples, aspects of the operations of 2010 may be performed by an uplink message component 1630 as described with reference to FIG. 16.

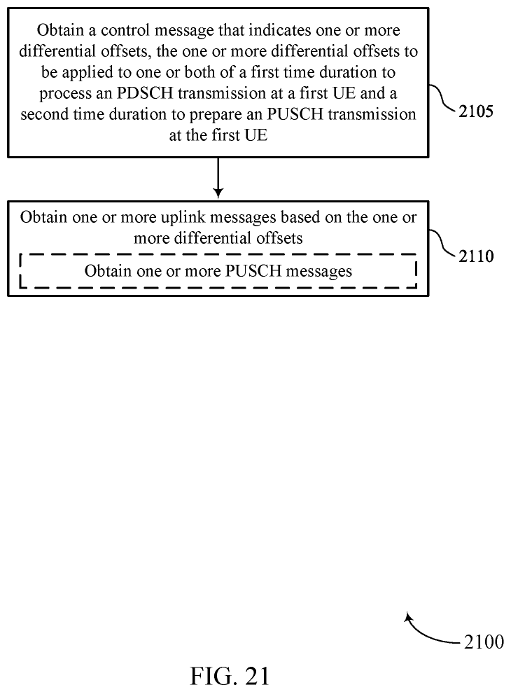

FIG. 21 shows a flowchart illustrating a method 2100 that supports differential offsets for cooperative reception between multiple UEs in accordance with aspects of the present disclosure. The operations of the method 2100 may be implemented by a network entity or its components as described herein. For example, the operations of the method 2100 may be performed by a network entity as described with reference to FIGS. 1-9 and 14-17. In some examples, a network entity may execute a set of instructions to control the functional elements of the network entity to perform the described functions. Additionally, or alternatively, the network entity may perform aspects of the described functions using special-purpose hardware.

At 2105, the method may include obtaining a control message that indicates one or more differential offsets, the one or more differential offsets to be applied to one or both of a first time duration to process an PDSCH transmission at a first UE and a second time duration to prepare an PUSCH transmission at the first UE. The operations of block 2105 may be performed in accordance with examples as disclosed herein. In some examples, aspects of the operations of 2105 may be performed by a control message component 1625 as described with reference to FIG. 16.

At 2110, the method may include obtaining one or more uplink messages based on the one or more differential offsets, where the one or more uplink messages include one or more PUSCH messages. The operations of block 2110 may be performed in accordance with examples as disclosed herein. In some examples, aspects of the operations of 2110 may be performed by an uplink message component 1630 as described with reference to FIG. 16.

The following aspects are given by way of illustration. Examples of the following aspects may be combined with examples or embodiments shown or discussed in relation to the figures or elsewhere herein.

Aspect 1 is a method for wireless communication by a first UE that includes transmitting a control message that indicates one or more differential offsets, the one or more differential offsets to be applied to one or both of a first time duration to process an PDSCH transmission at the first UE and a second time duration to prepare an PUSCH transmission at the first UE; and transmitting one or more uplink messages based at least in part on the one or more differential offsets.

In Aspect 2, the transmitting one or more uplink messages of aspect 1 includes transmitting one or more PUSCH messages.

In Aspect 3, the method of aspect 2 further includes receiving a DCI message scheduling a plurality of PUSCH occasions, wherein each respective PUSCH occasion is associated with a respective slot offset between downlink control message reception and uplink data transmission; and transmitting a PUSCH message of the one or more PUSCH messages via one of the plurality of PUSCH occasions based at least in part on the one or more differential offsets.

In Aspect 4, the method of any of aspects 1-3 further includes receiving information associated with a data message from both a network entity via a downlink communication link and a second UE via a sidelink communication link in association with a cooperative reception between the first UE and the second UE; and transmitting feedback associated with the data message, wherein the one or more uplink messages include the feedback.

In Aspect 5, the method of aspect 4 further includes communicating second information associated with one or both of a link condition between the first UE and the second UE and a type of cooperation between the first UE and the second UE, wherein the one or more differential offsets are based at least in part on one or both of the link condition and the type of cooperation.

In Aspect 6, the type of cooperation of aspect 5 includes at least a forwarding of I/Q samples, and receiving the information associated with the data message includes receiving the data message from the network entity and a plurality of I/Q samples associated with the data message from the second UE, the plurality of I/Q samples associated with a partial processing of the data message by the second UE in accordance with the type of cooperation.

In Aspect 7, the type of cooperation of any of aspects 5-6 includes at least a forwarding of LLR values, and receiving the information associated with the data message includes receiving the data message from the network entity and a plurality of LLR values associated with the data message from the second UE, the plurality of LLR values associated with a partial processing of the data message by the second UE in accordance with the type of cooperation.

In Aspect 8, the type of cooperation of any of aspects 5-7 includes at least a forwarding of TBs, and receiving the information associated with the data message includes receiving a first TB associated with the data message from the network entity and second TB associated with the data message from the second UE in accordance with the type of cooperation, wherein the first TB and the second TB each include the data message.

In Aspect 9, the method of any of aspects 4-8 further includes receiving a control signal that indicates a plurality of slot offset pairs and a plurality of PRIs corresponding to the plurality of slot offset pairs; and selecting a PRI of the plurality of PRIs in accordance with at least one of the one or more differential offsets, wherein the feedback is transmitted via a PUCCH resource corresponding to the selected PRI.

In Aspect 10, the plurality of slot offset pairs of aspect 9 including a first slot offset between PDSCH reception and feedback transmission and a second slot offset between downlink control message reception and uplink data transmission, a second slot offset pair of the plurality of slot offset pairs comprises a third slot offset between PDSCH reception and feedback transmission and a fourth slot offset between downlink control message reception and uplink data transmission, a first PRI of the plurality of PRIs corresponds to the first slot offset, and a second PRI of the plurality of PRIs corresponds to the third slot offset.

In Aspect 11, the receiving the information associated with the data message of any of aspects 4-10 includes receiving the information associated with the data message from both the network entity and the second UE in accordance with a quantity of antennas of the first UE, the quantity of antennas at the first UE being below a threshold quantity of antennas, wherein the control message that indicates the one or more differential offsets is transmitted based at least in part on the quantity of antennas at the first UE being below the threshold quantity.

In Aspect 12, the method of any of aspects 4-11, wherein a summation of a first quantity of antennas of the first UE and a second quantity of antennas of the second UE satisfy a threshold quantity of antennas, and transmitting the control message that indicates the one or more differential offsets is based at least in part on the summation of the first quantity of antennas and the second quantity of antennas satisfying the threshold quantity of antennas, and the cooperative reception between the first UE and the second UE is based at least in part on the summation of the first quantity of antennas and the second quantity of antennas of the second UE satisfying the threshold quantity of antennas.

In Aspect 13, the transmitting the control message of any of aspects 1-12 includes transmitting an indication of a first differential offset and a second differential offset, wherein the one or more differential offsets include the first differential offset and the second differential offset, and wherein the first differential offset is to be applied to the first time duration process the PDSCH transmission at the first UE and the second differential offset is to be applied to the second time duration to prepare the PUSCH transmission at the first UE.

In Aspect 14, the control message of aspect 13 further indicates a plurality of offset pairs, a first offset pair of the plurality of offset pairs including the first differential offset and the second differential offset, the method further that includes transmitting an UCI message indicating that the first offset pair is to be applied prior to transmitting the one or more uplink messages, wherein the one or more uplink messages are transmitted based at least in part on the UCI message and the first offset pair.

In Aspect 15, the method of any of aspects 1-14 further includes receiving a control signal that indicates a first slot offset between reception of an PDSCH and transmission of the feedback and that indicates a second slot offset between reception of a downlink control message and transmission of uplink data, wherein the first slot offset and the second slot offset are based at least in part on the one or more differential offsets, and wherein the one or more uplink messages are transmitted according to at least the first slot offset or the second slot offset.

In Aspect 16, the method of any of aspects 1-15 further includes applying the one or more differential offsets based at least in part on reception of a DCI message after transmitting the control message, wherein the one or more uplink messages are transmitted based at least in part on applying the one or more differential offsets.

In Aspect 17, the DCI of aspect 16 indicates an HARQ identifier which corresponds to a HARQ identifier associated with the control message.

In Aspect 18, the method of any of aspects 1-17 further includes receiving a response to the control message from the network entity; and applying the one or more differential offsets based at least in part on receiving the response, wherein the one or more uplink messages are transmitted based at least in part on applying the one or more differential offsets.

In Aspect 19, the method of any of aspects 1-18 further includes applying the one or more differential offsets after transmitting the control message, wherein the control message includes an UCI message, and wherein the one or more uplink messages are transmitted based at least in part on applying the one or more differential offsets.

In Aspect 20, the applying the one or more differential offsets of aspect 19 includes applying the one or more differential offsets directly after transmitting the control message.

In Aspect 21, the control message of any of aspects 1-20 includes a MAC-CE message.

In Aspect 22, the method of any of aspects 1-21 further includes receiving an indication of a configured uplink grant via which to transmit the control message that indicates the one or more differential offsets, wherein the control message is transmitted via the configured uplink grant.

In Aspect 23, the method of any of aspects 1-22 further includes transmitting a request for uplink resources via which to transmit the control message that indicates the one or more differential offsets; and receiving an allocation of the uplink resources, wherein the control message is transmitted via the uplink resources.

In Aspect 24, the method of any of aspects 1-23 further includes receiving an RRC message or a MAC-CE message configuring an offset between a first uplink transmission occasion and a second uplink transmission occasion; and transmitting an uplink message of the one or more uplink messages via one of the first uplink transmission occasion and the second uplink transmission occasion based at least in part on the one or more differential offsets.

Aspect 25 is a method for wireless communication by a network entity, that includes obtaining a control message that indicates one or more differential offsets, the one or more differential offsets to be applied to one or both of a first time duration to process an PDSCH transmission at a first UE and a second time duration to prepare an PUSCH transmission at the first UE; and obtaining one or more uplink messages based at least in part on the one or more differential offsets.

In Aspect 26, obtaining the one or more uplink messages of aspect 25 includes obtaining one or more PUSCH messages.

In Aspect 27, the method of aspect 26 further includes outputting a DCI message scheduling a plurality of PUSCH occasions, wherein each respective PUSCH occasion is associated with a respective slot offset between downlink control message reception and uplink data transmission; and obtaining a PUSCH message of the one or more PUSCH messages via one of the plurality of PUSCH occasions based at least in part on the one or more differential offsets.

In Aspect 28, the method of any of aspects 25-27 further includes obtaining information associated with a data message to the first UE and to a second UE in association with a cooperative reception between the first UE and the second UE; and obtaining the one or more uplink messages, wherein the one or more uplink messages include feedback associated with the data message.

In Aspect 29, outputting the data message of aspect 28 includes outputting the data message to the first UE and the second UE in association with the cooperative reception between the first UE and the second UE in accordance with a quantity of antennas of the first UE, the quantity of antennas at the first UE being below a threshold quantity of antennas, wherein the control message that indicates the one or more differential offsets is obtained based at least in part on the quantity of antennas at the first UE being below the threshold quantity.

In Aspect 30, the method of any of aspects 28-29 further includes outputting a control signal that indicates a plurality of slot offset pairs and a plurality of PRIs corresponding to the plurality of slot offset pairs, wherein the feedback is obtained via a PUCCH resource corresponding to a selected PRI of the plurality of PRIs.

In Aspect 31, the plurality of slot offset pairs of aspect 30 includes a first slot offset between PDSCH transmission and feedback reception and a second slot offset between downlink control message transmission and uplink data reception, a second slot offset pair of the plurality of slot offset pairs comprises a third slot offset between PDSCH transmission and feedback reception and a fourth slot offset between downlink control message transmission and uplink data reception, a first PRI of the plurality of PRIs corresponds to the first slot offset, and a second PRI of the plurality of PRIs corresponds to the third slot offset.

In Aspect 32, receiving the control message of any of aspects 25-31 includes obtaining an indication of a first differential offset and a second differential offset, wherein the one or more differential offsets include the first differential offset and the second differential offset, and wherein the first differential offset is to be applied to the first time duration process the PDSCH transmission at the first UE and the second differential offset is to be applied to the second time duration to prepare the PUSCH transmission at the first UE.

In Aspect 33, the control message of aspect 32 further indicates a plurality of offset pairs, a first offset pair of the plurality of offset pairs including the first differential offset and the second differential offset, the method further that includes obtaining an UCI message indicating that the first offset pair is to be applied prior to obtaining the one or more uplink messages, wherein the one or more uplink messages are obtained based at least in part on the UCI message and the first offset pair.

In Aspect 34, the method of any of aspects 25-33 further includes outputting a control signal that indicates a first slot offset between transmission of an PDSCH and reception of the feedback and that indicates a second slot offset between transmission of a downlink control message and reception of uplink data, wherein the first slot offset and the second slot offset are based at least in part on the one or more differential offsets, and wherein the one or more uplink messages are obtained according to at least the first slot offset or the second slot offset.

In Aspect 35, the control message of any of aspects 25-34 includes a MAC-CE message.

In Aspect 36, the method of any of aspects 25-35 further includes outputting an indication of a configured uplink grant via which to receive the control message that indicates the one or more differential offsets, wherein the control message is obtained based at least in part on the configured uplink grant.

In Aspect 37, the method of any of aspects 25-36 further includes obtaining a request for uplink resources associated with the control message that indicates the one or more differential offsets; and outputting an allocation of the uplink resources, wherein the control message is obtained based at least in part on the uplink resources.

In Aspect 38, the method of any of aspects 25-37 further includes outputting an RRC message or a MAC-CE message configuring an offset between a first uplink transmission occasion and a second uplink transmission occasion; and obtaining an uplink message of the one or more uplink messages via one of the first uplink transmission occasion and the second uplink transmission occasion based at least in part on the one or more differential offsets.

In Aspect 39, the method of any of aspects 25-38, wherein a summation of a first quantity of antennas of the first UE and a second quantity of antennas of the second UE satisfy a threshold quantity of antennas, and the control message that indicates the one or more differential offsets is obtained based at least in part on the summation of the first quantity of antennas and the second quantity of antennas satisfying the threshold quantity of antennas, and the cooperative reception between the first UE and the second UE is based at least in part on the summation of the first quantity of antennas and the second quantity of antennas of the second UE satisfying the threshold quantity of antennas.

Aspect 40 is a first UE for wireless communication, comprising one or more memories storing processor-executable code, and one or more processors coupled with the one or more memories and individually or collectively operable to execute the code to cause the first UE to perform a method as in any of aspects 1-24.

Aspect 41 is a system or apparatus including one or more processors and memory in electronic communication with the one or more processors storing instructions executable by the one or more processors to cause the system or apparatus to implement a method as in any of aspects 1-24.

Aspect 42 is a system or apparatus (e.g., a first UE) including means for implementing a method or realizing an apparatus as in any of aspects 1-24.

Aspect 43 is a non-transitory computer-readable medium storing instructions executable by one or more processors to cause the one or more processors to implement a method as in any of aspects 1-24.

Aspect 44 is a network entity comprising one or more memories storing processor-executable code, and one or more processors coupled with the one or more memories and individually or collectively operable to execute the code to cause the network entity to perform a method as in any of aspects 25-39.

Aspect 45 is a system or apparatus including one or more processors and memory in electronic communication with the one or more processors storing instructions executable by the one or more processors to cause the system or apparatus to implement a method as in any of aspects 25-39.

Aspect 46 is a system or apparatus (e.g., a network entity) including means for implementing a method or realizing an apparatus as in any of aspects 25-39.

Aspect 47 is a non-transitory computer-readable medium storing instructions executable by one or more processors to cause the one or more processors to implement a method as in any of aspects 25-39.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
transmit a control message that indicates one or more differential offsets, the one or more differential offsets to be applied to one or both of a first time duration to process a physical downlink shared channel (PDSCH) transmission at the first UE and a second time duration to prepare a physical uplink shared channel (PUSCH) transmission at the first UE; and
transmit one or more uplink messages based at least in part on the one or more differential offsets.

2. The first UE of claim 1, wherein, to transmit the one or more uplink messages, the one or more processors are individually or collectively operable to execute the code to cause the first UE to:
transmit one or more physical uplink shared channel (PUSCH) messages.

3. The first UE of claim 2, wherein the one or more processors are individually or collectively further operable to execute the code to cause the first UE to:
receive a downlink control information (DCI) message scheduling a plurality of PUSCH occasions, wherein each respective PUSCH occasion is associated with a respective slot offset between downlink control message reception and uplink data transmission; and
transmit a PUSCH message of the one or more PUSCH messages via one of the plurality of PUSCH occasions based at least in part on the one or more differential offsets.

4. The first UE of claim 1, wherein the one or more processors are individually or collectively further operable to execute the code to cause the first UE to:
receive information associated with a data message from both a network entity via a downlink communication link and a second UE via a sidelink communication link in association with a cooperative reception between the first UE and the second UE; and
transmit feedback associated with the data message, wherein the one or more uplink messages include the feedback.

5. The first UE of claim 4, wherein the one or more processors are individually or collectively further operable to execute the code to cause the first UE to:
communicate second information associated with one or both of a link condition between the first UE and the second UE and a type of cooperation between the first UE and the second UE, wherein the one or more differential offsets are based at least in part on one or both of the link condition and the type of cooperation.

6. The first UE of claim 5, wherein, to receive the information associated with the data message, the one or more processors are individually or collectively operable to execute the code to cause the first UE to:
receive the data message from the network entity and a plurality of I/Q samples associated with the data message from the second UE, the plurality of I/Q samples associated with a partial processing of the data message by the second UE in accordance with the type of cooperation.

7. The first UE of claim 5, wherein, to receive the information associated with the data message, the one or more processors are individually or collectively operable to execute the code to cause the first UE to:
receive the data message from the network entity and a plurality of LLR values associated with the data message from the second UE, the plurality of LLR values associated with a partial processing of the data message by the second UE in accordance with the type of cooperation.

8. The first UE of claim 5, wherein, to receive the information associated with the data message, the one or more processors are individually or collectively operable to execute the code to cause the first UE to:
receive a first TB associated with the data message from the network entity and second TB associated with the data message from the second UE in accordance with the type of cooperation, wherein the first TB and the second TB each include the data message.

9. The first UE of claim 4, wherein the one or more processors are individually or collectively further operable to execute the code to cause the first UE to:
receive a control signal that indicates a plurality of slot offset pairs and a plurality of physical uplink control channel (PUCCH) resource indicators (PRIs) corresponding to the plurality of slot offset pairs; and
select a PRI of the plurality of PRIs in accordance with at least one of the one or more differential offsets, wherein the feedback is transmitted via a PUCCH resource corresponding to the selected PRI.

10. The first UE of claim 9, wherein:
a first slot offset pair of the plurality of slot offset pairs comprises a first slot offset between physical downlink shared channel (PDSCH) reception and feedback transmission and a second slot offset between downlink control message reception and uplink data transmission;
a second slot offset pair of the plurality of slot offset pairs comprises a third slot offset between PDSCH reception and feedback transmission and a fourth slot offset between downlink control message reception and uplink data transmission;
a first PRI of the plurality of PRIs corresponds to the first slot offset; and
a second PRI of the plurality of PRIs corresponds to the third slot offset.

11. The first UE of claim 4, wherein, to receive the information associated with the data message, the one or more processors are individually or collectively operable to execute the code to cause the first UE to:
receive the information associated with the data message from both the network entity and the second UE in accordance with a quantity of antennas of the first UE, the quantity of antennas at the first UE being below a threshold quantity of antennas, wherein the control message that indicates the one or more differential offsets is transmitted based at least in part on the quantity of antennas at the first UE being below the threshold quantity.

12. The first UE of claim 4, wherein:
a summation of a first quantity of antennas of the first UE and a second quantity of antennas of the second UE satisfy a threshold quantity of antennas;
transmitting the control message that indicates the one or more differential offsets is based at least in part on the summation of the first quantity of antennas and the second quantity of antennas satisfying the threshold quantity of antennas; and
the cooperative reception between the first UE and the second UE is based at least in part on the summation of the first quantity of antennas and the second quantity of antennas of the second UE satisfying the threshold quantity of antennas.

13. The first UE of claim 1, wherein, to transmit the control message, the one or more processors are individually or collectively operable to execute the code to cause the first UE to:
transmit an indication of a first differential offset and a second differential offset, wherein the one or more differential offsets include the first differential offset and the second differential offset, and wherein the first differential offset is to be applied to the first time duration process the PDSCH transmission at the first UE and the second differential offset is to be applied to the second time duration to prepare the PUSCH transmission at the first UE.

14. The first UE of claim 13, wherein the control message further indicates a plurality of offset pairs, and the one or more processors are individually or collectively further operable to execute the code to cause the first UE to:
transmit an uplink control information (UCI) message indicating that the first offset pair is to be applied prior to transmitting the one or more uplink messages, wherein the one or more uplink messages are transmitted based at least in part on the UCI message and the first offset pair.

15. The first UE of claim 1, wherein the one or more processors are individually or collectively further operable to execute the code to cause the first UE to:
receive a control signal that indicates a first slot offset between reception of a physical downlink shared channel (PDSCH) and transmission of feedback and that indicates a second slot offset between reception of a downlink control message and transmission of uplink data, wherein the first slot offset and the second slot offset are based at least in part on the one or more differential offsets, and wherein the one or more uplink messages are transmitted according to at least the first slot offset or the second slot offset.

16. A network entity, comprising:
one or more memories storing processor-executable code; and
one or more processors coupled with the one or more memories and individually or collectively operable to execute the code to cause the network entity to:
obtain a control message that indicates one or more differential offsets, the one or more differential offsets to be applied to one or both of a first time duration to process a physical downlink shared channel (PDSCH) transmission at a first UE and a second time duration to prepare a physical uplink shared channel (PUSCH) transmission at the first UE; and
obtain one or more uplink messages based at least in part on the one or more differential offsets.

17. The network entity of claim 16, wherein the control message includes a medium access control-control element (MAC-CE) message.

18. The network entity of claim 16, wherein the one or more processors are individually or collectively further operable to execute the code to cause the network entity to:
output an indication of a configured uplink grant via which to receive the control message that indicates the one or more differential offsets, wherein the control message is obtained based at least in part on the configured uplink grant.

19. The network entity of claim 16, wherein the one or more processors are individually or collectively further operable to execute the code to cause the network entity to:
obtain a request for uplink resources associated with the control message that indicates the one or more differential offsets; and
output an allocation of the uplink resources, wherein the control message is obtained based at least in part on the uplink resources.

20. A method for wireless communication by a first user equipment (UE), comprising:
transmitting a control message that indicates one or more differential offsets, the one or more differential offsets to be applied to one or both of a first time duration to process a physical downlink shared channel (PDSCH) transmission at the first UE and a second time duration to prepare a physical uplink shared channel (PUSCH) transmission at the first UE; and
transmitting one or more uplink messages based at least in part on the one or more differential offsets.

21. The method of claim 20, further comprising:
receiving a control signal that indicates a first slot offset between reception of a physical downlink shared channel (PDSCH) and transmission of feedback and that indicates a second slot offset between reception of a downlink control message and transmission of uplink data, wherein the first slot offset and the second slot offset are based at least in part on the one or more differential offsets, and wherein the one or more uplink messages are transmitted according to at least the first slot offset or the second slot offset.

22. The method of claim 20, further comprising:
applying the one or more differential offsets based at least in part on reception of a downlink control information (DCI) message after transmitting the control message, wherein the one or more uplink messages are transmitted based at least in part on applying the one or more differential offsets.

23. The method of claim 22, wherein the DCI message indicates a hybrid automatic repeat request (HARQ) identifier which corresponds to a HARQ identifier associated with the control message.

24. The method of claim 20, further comprising:
receiving a response to the control message from a network entity; and
applying the one or more differential offsets based at least in part on receiving the response, wherein the one or more uplink messages are transmitted based at least in part on applying the one or more differential offsets.

25. The method of claim 20, further comprising:
applying the one or more differential offsets after transmitting the control message, wherein the control message includes an uplink control information (UCI) message, and wherein the one or more uplink messages are transmitted based at least in part on applying the one or more differential offsets.

26. The method of claim 25, wherein applying the one or more differential offsets comprises:
applying the one or more differential offsets directly after transmitting the control message.

27. A method for wireless communication by a network entity, comprising:
obtaining a control message that indicates one or more differential offsets, the one or more differential offsets to be applied to one or both of a first time duration to process a physical downlink shared channel (PDSCH) transmission at a first UE and a second time duration to prepare a physical uplink shared channel (PUSCH) transmission at the first UE; and
obtaining one or more uplink messages based at least in part on the one or more differential offsets.

28. The method of claim 27, further comprising:
outputting a radio resource control (RRC) message or a medium access control-control element (MAC-CE) message configuring an offset between a first uplink transmission occasion and a second uplink transmission occasion; and
obtaining an uplink message of the one or more uplink messages via one of the first uplink transmission occasion and the second uplink transmission occasion based at least in part on the one or more differential offsets.

29. The method of claim 27, further comprising:
outputting a control signal that indicates a first slot offset between transmission of a physical downlink shared channel (PDSCH) and reception of feedback and that indicates a second slot offset between transmission of a downlink control message and reception of uplink data, wherein the first slot offset and the second slot offset are based at least in part on the one or more differential offsets, and wherein the one or more uplink messages are obtained according to at least the first slot offset or the second slot offset.

30. The method of claim 27, further comprising:
outputting a radio resource control (RRC) message or a medium access control-control element (MAC-CE) message configuring an offset between a first uplink transmission occasion and a second uplink transmission occasion; and
obtaining an uplink message of the one or more uplink messages via one of the first uplink transmission occasion and the second uplink transmission occasion based at least in part on the one or more differential offsets.
